(19) United States
(12) Patent Application Publication
(10) Pub. No.: US 2025/0150615 A1
(43) Pub. Date: May 8, 2025

(54) Template Matching Prediction with Block Vector Difference Refinement

(71) Applicant: Ofinno, LLC, Reston, VA (US)

(72) Inventor: Damian Ruiz Coll, Reston, VA (US)

(73) Assignee: Ofinno, LLC, Reston, VA (US)

(21) Appl. No.: 19/012,159

(22) Filed: Jan. 7, 2025

Related U.S. Application Data
(63) Continuation of application No. PCT/US2023/027151, filed on Jul. 7, 2023.
(60) Provisional application No. 63/359,142, filed on Jul. 7, 2022.

(51) Int. Cl. H04N 19/513; H04N 19/105; H04N 19/167; H04N 19/176

(52) U.S. Cl. CPC H04N 19/521; H04N 19/105; H04N 19/167; H04N 19/176

(57) ABSTRACT

A decoder determines, in a reference region having dimensions based on dimensions of a current block, a location of a first reference block (RB) based on a template of the current block and a template of the first RB. The decoder receives an indication of a block vector difference (BVD) from a bitstream. The decoder decodes the current block based on a second RB at a location that is displaced from the location of the first RB by the BVD.

### CROSS-REFERENCE TO RELATED APPLICATIONS

This application is a continuation of International Application No. PCT/US2023/027151, filed Jul. 7, 2023, which claims the benefit of U.S. Provisional Application No. 63/359,142, filed Jul. 7, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary video coding/decoding system in which embodiments of the present disclosure may be implemented.

FIG. 2 illustrates an exemplary encoder in which embodiments of the present disclosure may be implemented.

FIG. 3 illustrates an exemplary decoder in which embodiments of the present disclosure may be implemented.

FIG. 4 illustrates an example quadtree partitioning of a coding tree block (CTB) in accordance with embodiments of the present disclosure.

FIG. 5 illustrates a corresponding quadtree of the example quadtree partitioning of the CTB in FIG. 4 in accordance with embodiments of the present disclosure.

FIG. 6 illustrates example binary and ternary tree partitions in accordance with embodiments of the present disclosure.

FIG. 7 illustrates an example quadtree+multi-type tree partitioning of a CTB in accordance with embodiments of the present disclosure.

FIG. 8 illustrates a corresponding quadtree+multi-type tree of the example quadtree+multi-type tree partitioning of the CTB in FIG. 7 in accordance with embodiments of the present disclosure.

FIG. 9 illustrates an example set of reference samples determined for intra prediction of a current block being encoded or decoded in accordance with embodiments of the present disclosure.

FIG. 10A illustrates the 35 intra prediction modes supported by HEVC in accordance with embodiments of the present disclosure.

FIG. 10B illustrates the 67 intra prediction modes supported by HEVC in accordance with embodiments of the present disclosure.

FIG. 11 illustrates the current block and reference samples from FIG. 9 in a two-dimensional x, y plane in accordance with embodiments of the present disclosure.

FIG. 12 illustrates an example angular mode prediction of the current block from FIG. 9 in accordance with embodiments of the present disclosure.

FIG. 13A illustrates an example of inter prediction performed for a current block in a current picture being encoded in accordance with embodiments of the present disclosure.

FIG. 13B illustrates an example horizontal component and vertical component of a motion vector in accordance with embodiments of the present disclosure.

FIG. 14 illustrates an example of bi-prediction, performed for a current block in accordance with embodiments of the present disclosure.

FIG. 15A illustrates an example location of five spatial candidate neighboring blocks relative to a current block being coded in accordance with embodiments of the present disclosure.

FIG. 15B illustrates an example location of two temporal, co-located blocks relative to a current block being coded in accordance with embodiments of the present disclosure.

FIG. 16 illustrates an example of IBC applied for screen content in accordance with embodiments of the present disclosure.

FIG. 17 illustrates an example of template matching prediction (TMP) for predicting a current block (CB) in accordance with embodiments of the present disclosure.

FIG. 18 illustrates an example of a reference region, a reconstructed region, and coding tree unit (CTU) regions used in TMP in accordance with embodiments of the present disclosure.

FIG. 19 illustrates an example of TMP for predicting a current block (CB) 1902, according to embodiments of the present disclosure.

FIG. 20 illustrates an example representation of a BVD used in TMP in accordance with embodiments of the present disclosure.

FIG. 21 illustrates an example representation of a BVP, a BVD, and a BV used in TMP in accordance with embodiments of the present disclosure.

FIG. 22 illustrates an example representation of a BVD used in TMP in accordance with embodiments of the present disclosure.

FIG. 23 illustrates an example representation of a BVD used in TMP in accordance with embodiments of the present disclosure.

FIG. 24 illustrates an example of TMP combined with BVD refinement in accordance with embodiments of the present disclosure.

FIG. 25 illustrates a flowchart of a method for determining a BVP, determining a BV, and decoding a CB in accordance with embodiments of the present disclosure.

FIG. 26 illustrates a flowchart of a method for determining a BVP, determining a BVD, and signaling an indication of a BVD in accordance with embodiments of the present disclosure.

FIG. 27 illustrates a flowchart of a method for determining a BVP, determining a selected BVD based on determining a cost of one or more BVDs, and signaling a selected BVD in accordance with embodiments of the present disclosure.

FIG. 28 illustrates a flowchart of a method for determining a location of a first reference block (RB) using TMP and determining a plurality of candidate BVDs displaced from the location of the first RB for BVD refinement in accordance with embodiments of the present disclosure.

FIG. 29 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Representing a video sequence in digital form may require a large number of bits. The data size of a video sequence in digital form may be too large for storage and/or transmission in many applications. Video encoding may be used to compress the size of a video sequence to provide for more efficient storage and/or transmission. Video decoding may be used to decompress a compressed video sequence for display and/or other forms of consumption.

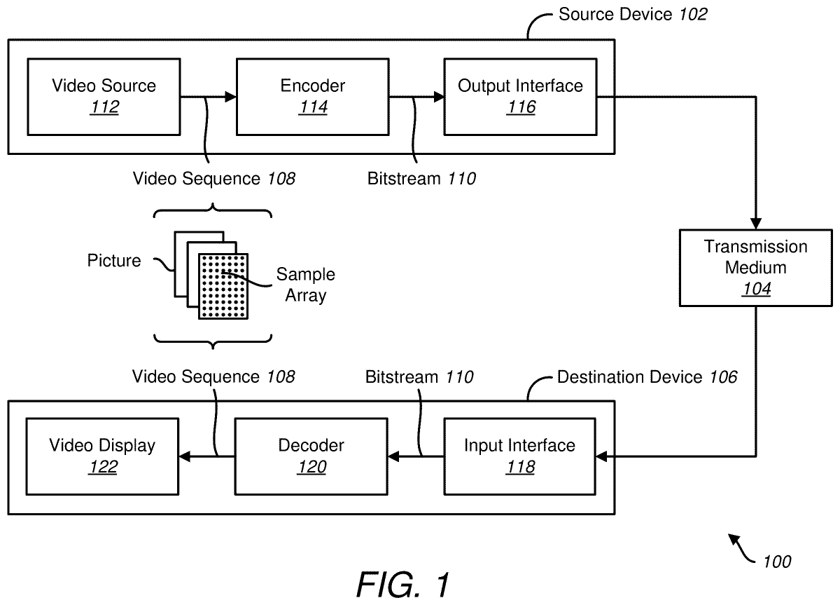

FIG. 1 illustrates an exemplary video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and destination device 106 may be any one of a number of different devices, including a desktop computer, laptop computer, tablet computer, smart phone, wearable device, television, camera, video gaming console, set-top box, or video streaming device.

To encode video sequence 108 into bitstream 110, source device 102 may comprise a video source 112, an encoder 114, and an output interface 116. Video source 112 may provide or generate video sequence 108 from a capture of a natural scene and/or a synthetically generated scene. A synthetically generated scene may be a scene comprising computer generated graphics or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A shown in FIG. 1, a video sequence, such as video sequence 108, may comprise a series of pictures (also referred to as frames). A video sequence may achieve the impression of motion when a constant or variable time is used to successively present pictures of the video sequence. A picture may comprise one or more sample arrays of intensity values. The intensity values may be taken at a series of regularly spaced locations within a picture. A color picture typically comprises a luminance sample array and two chrominance sample arrays. The luminance sample array may comprise intensity values representing the brightness (or luma component, Y) of a picture. The chrominance sample arrays may comprise intensity values that respectively represent the blue and red components of a picture (or chroma components, Cb and Cr) separate from the brightness. Other color picture sample arrays are possible based on different color schemes (e.g., an RGB color scheme). For color pictures, a pixel may refer to all three intensity values for a given location in the three sample arrays used to represent color pictures. A monochrome picture comprises a single, luminance sample array. For monochrome pictures, a pixel may refer to the intensity value at a given location in the single, luminance sample array used to represent monochrome pictures.

Encoder 114 may encode video sequence 108 into bitstream 110. To encode video sequence 108, encoder 114 may apply one or more prediction techniques to reduce redundant information in video sequence 108. Redundant information is information that may be predicted at a decoder and therefore may not be needed to be transmitted to the decoder for accurate decoding of the video sequence. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Before applying the one or more prediction techniques, encoder 114 may partition pictures of video sequence 108 into rectangular regions referred to as blocks. Encoder 114 may then encode a block using one or more of the prediction techniques.

For temporal prediction, encoder 114 may search for a block similar to the block being encoded in another picture (also referred to as a reference picture) of video sequence 108. The block determined during the search (also referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (also referred to as a residual) based on the difference between a block being encoded and a prediction block. The prediction error may represent non-redundant information that may be transmitted to a decoder for accurate decoding of a video sequence.

Encoder 114 may apply a transform to the prediction error (e.g. a discrete cosine transform (DCT)) to generate transform coefficients. Encoder 114 may form bitstream 110 based on the transform coefficients and other information used to determine prediction blocks (e.g., prediction types, motion vectors, and prediction modes). In some examples, encoder 114 may perform one or more of quantization and entropy coding of the transform coefficients and/or the other information used to determine prediction blocks before forming bitstream 110 to further reduce the number of bits needed to store and/or transmit video sequence 108.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into video sequence 108 for display, destination device 106 may comprise an input interface 118, a decoder 120, and a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode video sequence 108 from encoded bitstream 110. To decode video sequence 108, decoder 120 may generate prediction blocks for pictures of video sequence 108 in a similar manner as encoder 114 and determine prediction errors for the blocks. Decoder 120 may generate the prediction blocks using prediction types, prediction modes, and/or motion vectors received in bitstream 110 and determine the prediction errors using transform coefficients also received in bitstream 110. Decoder 120 may determine the prediction errors by weighting transform basis functions using the transform coefficients. Decoder 120 may combine the prediction blocks and prediction errors to decode video sequence 108. In some examples, decoder 120 may decode a video sequence that approximates video sequence 108 due to, for example, lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, liquid crystal display (LCD), a plasma display, light emitting diode (LED) display, or any other display device suitable for displaying video sequence 108.

It should be noted that video encoding/decoding system 100 is presented by way of example and not limitation. In the example of FIG. 1, video encoding/decoding system 100 may have other components and/or arrangements. For example, video source 112 may be external to source device 102. Similarly, video display (device) 122 may be external to destination device 106 or omitted altogether where video sequence is intended for consumption by a machine and/or storage device. In another example, source device 102 may further comprise a video decoder and destination device 106 may comprise a video encoder. In such an example, source device 102 may be configured to further receive an encoded bit stream from destination device 106 to support two-way video transmission between the devices.

In the example of FIG. 1, encoder 114 and decoder 120 may operate according to any one of a number of proprietary or industry video coding standards. For example, encoder 114 and decoder 120 may operate according to one or more of International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC), ITU-T H.265 and MPEG-I Part 3 (also known as Versatile Video Coding (VVC)), the WebM VP8 and VP9 codecs, and AOMedia Video 1 (AV1).

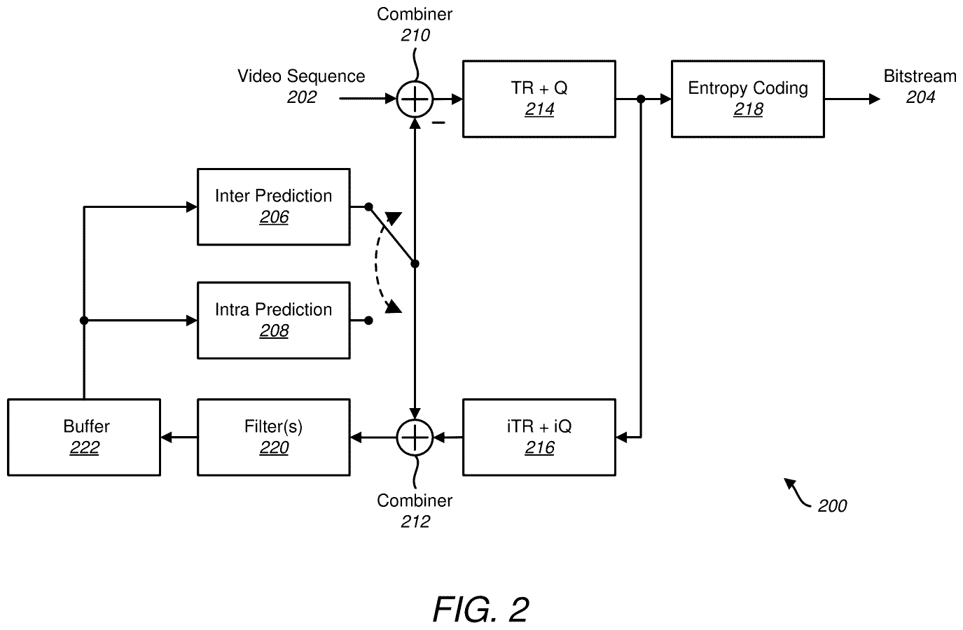

FIG. 2 illustrates an exemplary encoder 200 in which embodiments of the present disclosure may be implemented. Encoder 200 encodes a video sequence 202 into a bitstream 204 for more efficient storage and/or transmission. Encoder 200 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Encoder 200 comprises an inter prediction unit 206, an intra prediction unit 208, combiners 210 and 212, a transform and quantization unit (TR+Q) unit 214, an inverse transform and quantization unit (iTR+iQ) 216, entropy coding unit 218, one or more filters 220, and a buffer 222.

Encoder 200 may partition the pictures of video sequence 202 into blocks and encode video sequence 202 on a block-by-block basis. Encoder 200 may perform a prediction technique on a block being encoded using either inter prediction unit 206 or intra prediction unit 208. Inter prediction unit 206 may perform inter prediction by searching for a block similar to the block being encoded in another, reconstructed picture (also referred to as a reference picture) of video sequence 202. A reconstructed picture refers to a picture that was encoded and then decoded. The block determined during the search (also referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

After prediction, combiner 210 may determine a prediction error (also referred to as a residual) based on the difference between the block being encoded and the prediction block. The prediction error may represent non-redundant information that may be transmitted to a decoder for accurate decoding of a video sequence.

Transform and quantization unit 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. Irrelevant information is information that may be removed from the coefficients without producing visible and/or perceptible distortion in video sequence 202 after decoding.

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and syntax-based context-based binary arithmetic coding (SBAC). The entropy coded coefficients are packed to form bitstream 204.

Inverse transform and quantization unit 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block using, for example, a deblocking filter and/or a sample-adaptive offset (SAO) filter. Buffer 222 may store the reconstructed block for prediction of one or more other blocks in the same and/or different picture of video sequence 202.

Although not shown in FIG. 2, encoder 200 further comprises an encoder control unit configured to control one or more of the units of encoder 200 shown in FIG. 2. The encoder control unit may control the one or more units of encoder 200 such that bitstream 204 is generated in conformance with the requirements of any one of a number of proprietary or industry video coding standards. For example, the encoder control unit may control the one or more units of encoder 200 such that bitstream 204 is generated in conformance with one or more of ITU-T H.263, AVC, HEVC, VVC, VP8, VP9, and AV1 video coding standards.

Within the constraints of a proprietary or industry video coding standard, the encoder control unit may attempt to minimize or reduce the bitrate of bitstream 204 and maximize or increase the reconstructed video quality. For example, the encoder control unit may attempt to minimize or reduce the bitrate of bitstream 204 given a level that the reconstructed video quality may not fall below, or attempt to maximize or increase the reconstructed video quality given a level that the bit rate of bitstream 204 may not exceed. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and one or more transform types and/or quantization parameters applied by transform and quantization unit 214. The encoder control unit may determine/control the above based on how the determination/control effects a rate-distortion measure for a block or picture being encoded. The encoder control unit may determine/control the above to reduce the rate-distortion measure for a block or picture being encoded.

After being determined, the prediction type used to encode a block (intra or inter prediction), prediction information of the block (intra prediction mode if intra predicted, motion vector, etc.), and transform and quantization parameters, may be sent to entropy coding unit 218 to be further compressed to reduce the bit rate. The prediction type, prediction information, and transform and quantization parameters may be packed with the prediction error to form bitstream 204.

It should be noted that encoder 200 is presented by way of example and not limitation. In other examples, encoder 200 may have other components and/or arrangements. For example, one or more of the components shown in FIG. 2 may be optionally included in encoder 200, such as entropy coding unit 218 and filters(s) 220.

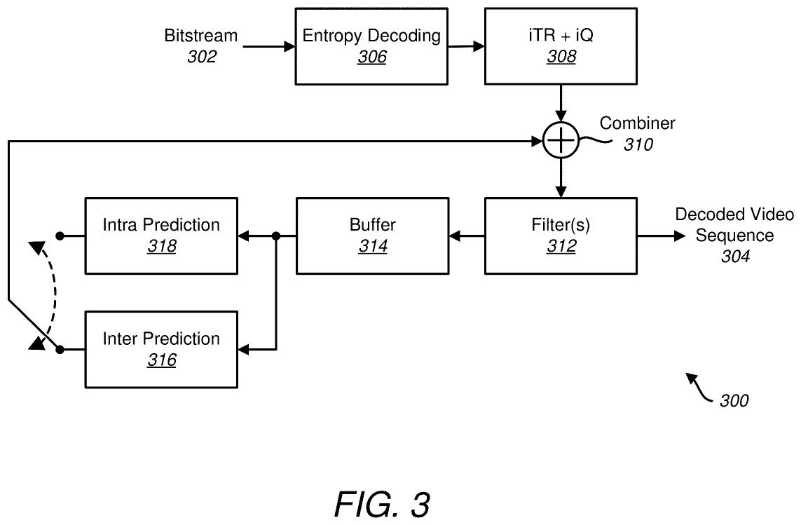

FIG. 3 illustrates an exemplary decoder 300 in which embodiments of the present disclosure may be implemented. Decoder 300 decodes a bitstream 302 into a decoded video sequence for display and/or some other form of consumption. Decoder 300 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Decoder 300 comprises an entropy decoding unit 306, an inverse transform and quantization (iTR+iQ) unit 308, a combiner 310, one or more filters 312, a buffer 314, an inter prediction unit 316, and an intra prediction unit 318.

Although not shown in FIG. 3, decoder 300 further comprises a decoder control unit configured to control one or more of the units of decoder 300 shown in FIG. 3. The decoder control unit may control the one or more units of decoder 300 such that bitstream 302 is decoded in conformance with the requirements of any one of a number of proprietary or industry video coding standards. For example, the decoder control unit may control the one or more units of decoder 300 such that bitstream 302 is decoded in conformance with one or more of ITU-T H.263, AVC, HEVC, VVC, VP8, VP9, and AV1 video coding standards.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. Inverse transform and quantization unit 308 may inverse quantize and inverse transform the quantized transform coefficients to determine a decoded prediction error. Combiner 310 may combine the decoded prediction error with a prediction block to form a decoded block. The prediction block may be generated by inter prediction unit 318 or inter prediction unit 316 as described above with respect to encoder 200 in FIG. 2. Filter(s) 312 may filter the decoded block using, for example, a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

It should be noted that decoder 300 is presented by way of example and not limitation. In other examples, decoder 300 may have other components and/or arrangements. For example, one or more of the components shown in FIG. 3 may be optionally included in decoder 300, such as entropy decoding unit 306 and filters(s) 312.

It should be further noted that, although not shown in FIGS. 2 and 3, each of encoder 200 and decoder 300 may further comprise an intra block copy unit in addition to inter prediction and intra prediction units. The intra block copy unit may perform similar to an inter prediction unit but predict blocks within the same picture. For example, the intra block copy unit may exploit repeated patterns that appear in screen content. Screen content may include, for example, computer generated text, graphics, and animation.

As mentioned above, video encoding and decoding may be performed on a block-by-block basis. The process of partitioning a picture into blocks may be adaptive based on the content of the picture. For example, larger block partitions may be used in areas of a picture with higher levels of homogeneity to improve coding efficiency.

In HEVC, a picture may be partitioned into non-overlapping square blocks, referred to as coding tree blocks (CTBs), comprising samples of a sample array. A CTB may have a size of 2ⁿ×2ⁿ samples, where n may be specified by a parameter of the encoding system. For example, n may be 4, 5, or 6. A CTB may be further partitioned by a recursive quadtree partitioning into coding blocks (CBs) of half vertical and half horizontal size. The CTB forms the root of the quadtree. A CB that is not split further as part of the recursive quadtree partitioning may be referred to as a leaf-CB of the quadtree and otherwise as a non-leaf CB of the quadtree. A CB may have a minimum size specified by a parameter of the encoding system. For example, a CB may have a minimum size of 4×4, 8×8, 16×16, 32×32, or 64×64 samples. For inter and intra prediction, a CB may be further partitioned into one or more prediction blocks (PBs) for performing inter and intra prediction. A PB may be a rectangular block of samples on which the same prediction type/mode m ay be applied. For transformations, a CB may be partitioned into one or more transform blocks (TBs). A TB may be a rectangular block of samples that may determine an applied transform size.

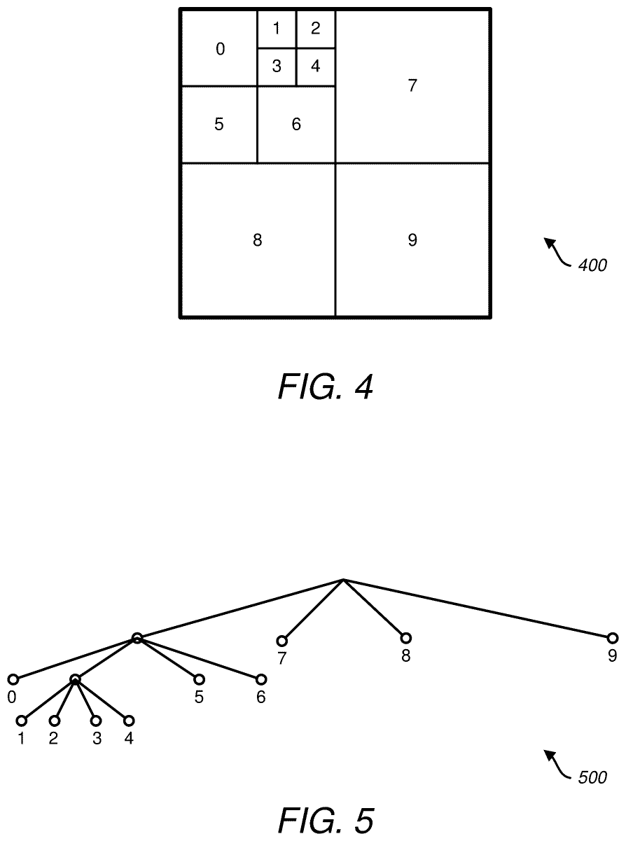

FIG. 4 illustrates an example quadtree partitioning of a CTB 400. FIG. 5 illustrates a corresponding quadtree 500 of the example quadtree partitioning of CTB 400 in FIG. 4. As shown in FIGS. 4 and 5, CTB 400 is first partitioned into four CBs of half vertical and half horizontal size. Three of the resulting CBs of the first level partitioning of CTB 400 are leaf-CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

Altogether, CTB 400 is partitioned into 10 leaf CBs respectively labeled 0-9. The resulting quadtree partitioning of CTB 400 may be scanned using a z-scan (left-to-right, top-to-bottom) to form the sequence order for encoding/decoding the CB leaf nodes. The numeric label of each CB leaf node in FIGS. 4 and 5 may correspond to the sequence order for encoding/decoding, with CB leaf node 0 encoded/decoded first and CB leaf node 9 encoded/decoded last. Although not shown in FIGS. 4 and 5, it should be noted that each CB leaf node may comprise one or more PBs and TBs.

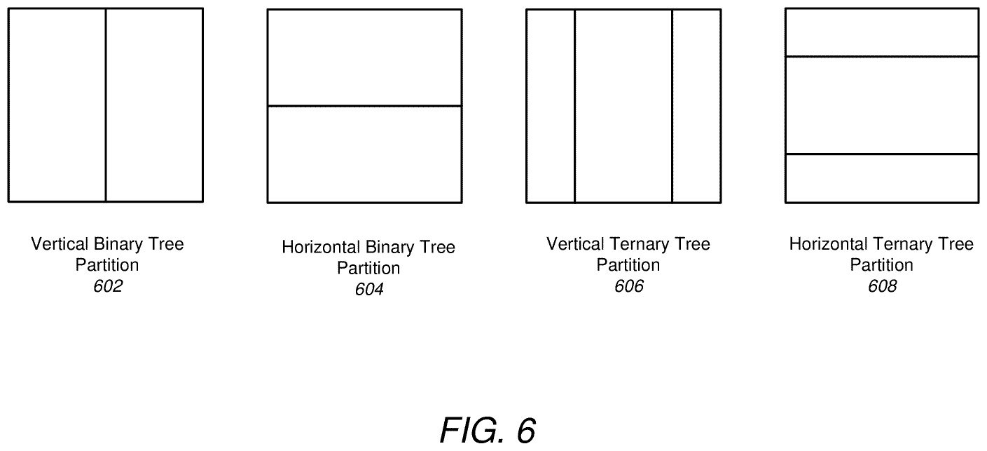

In VVC, a picture may be partitioned in a similar manner as in HEVC. A picture may be first partitioned into non-overlapping square CTBs. The CTBs may then be partitioned by a recursive quadtree partitioning into CBs of half vertical and half horizontal size. In VVC, a quadtree leaf node may be further partitioned by a binary tree or ternary tree partitioning into CBs of unequal sizes. FIG. 6 illustrates example binary and ternary tree partitions. A binary tree partition may divide a parent block in half in either the vertical direction 602 or horizontal direction 604. The resulting partitions may be half in size as compared to the parent block. A ternary tree partition may divide a parent block into three parts in either the vertical direction 606 or horizontal direction 608. The middle partition may be twice as large as the other two end partitions in a ternary tree partition.

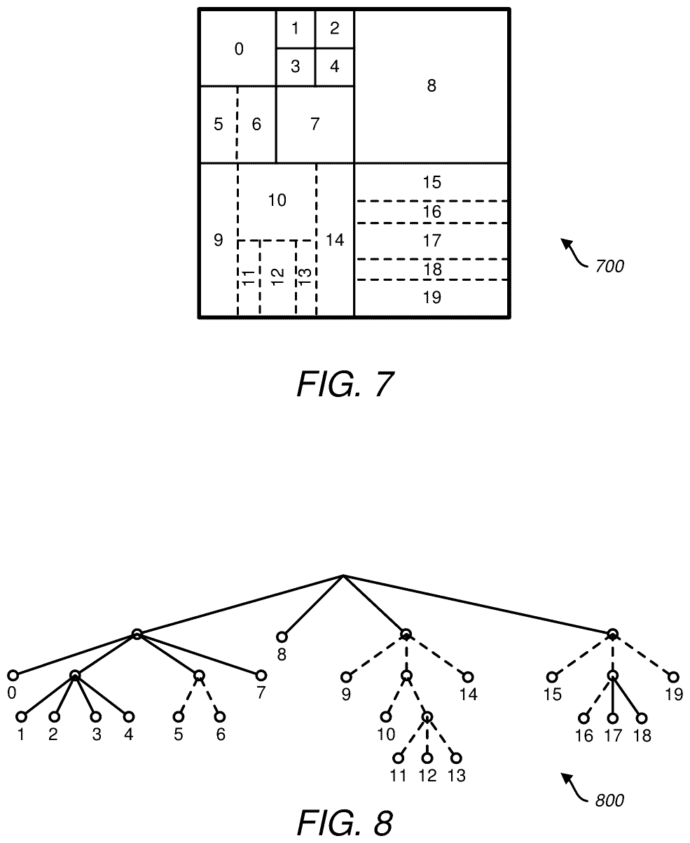

Because of the addition of binary and ternary tree partitioning, in VVC the block partitioning strategy may be referred to as quadtree+multi-type tree partitioning. FIG. 7 illustrates an example quadtree+multi-type tree partitioning of a CTB 700. FIG. 8 illustrates a corresponding quadtree+multi-type tree 800 of the example quadtree+multi-type tree partitioning of CTB 700 in FIG. 7. In both FIGS. 7 and 8, quadtree splits are shown in solid lines and multi-type tree splits are shown in dashed lines. For ease of explanation, CTB 700 is shown with the same quadtree partitioning as CTB 400 described in FIG. 4. Therefore, description of the quadtree partitioning of CTB 700 is omitted. The description of the additional multi-type tree partitions of CTB 700 is made relative to three leaf-CBs shown in FIG. 4 that have been further partitioned using one or more binary and ternary tree partitions. The three leaf-CBs in FIG. 4 that are shown in FIG. 7 as being further partitioned are leaf-CBs 5, 8, and 9.

Starting with leaf-CB 5 in FIG. 4, FIG. 7 shows this leaf-CB partitioned into two CBs based on a vertical binary tree partitioning. The two resulting CBs are leaf-CBs respectively labeled 5 and 6 in FIGS. 7 and 8. With respect to leaf-CB 8 in FIG. 4, FIG. 7 shows this leaf-CB partitioned into three CBs based on a vertical ternary tree partition. Two of the three resulting CBs are leaf-CBs respectively labeled 9 and 14 in FIGS. 7 and 8. The remaining, non-leaf CB is partitioned first into two CBs based on a horizontal binary tree partition, one of which is a leaf-CB labeled 10 and the other of which is further partitioned into three CBs based on a vertical ternary tree partition. The resulting three CBs are leaf-CBs respectively labeled 11, 12, and 13 in FIGS. 7 and 8. Finally, with respect to leaf-CB 9 in FIG. 4, FIG. 7 shows this leaf-CB partitioned into three CBs based on a horizontal ternary tree partition. Two of the three CBs are leaf-CBs respectively labeled 15 and 19 in FIGS. 7 and 8. The remaining, non-leaf CB is partitioned into three CBs based on another horizontal ternary tree partition. The resulting three CBs are all leaf-CBs respectively labeled 16, 17, and 18 in FIGS. 7 and 8.

Altogether, CTB 700 is partitioned into 20 leaf CBs respectively labeled 0-19. The resulting quadtree+multi-type tree partitioning of CTB 700 may be scanned using a z-scan (left-to-right, top-to-bottom) to form the sequence order for encoding/decoding the CB leaf nodes. The numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and TBs.

In addition to specifying various blocks (e.g., CTB, CB, PB, TB), HEVC and VVC further define various units. While blocks may comprise a rectangular area of samples in a sample array, units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bit stream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

It should be noted that the term block may be used to refer to any of a CTB, CB, PB, TB, CTU, CU, PU, or TU in the context of HEVC and VVC. It should be further noted that the term block may be used to refer to similar data structures in the context of other video coding standards. For example, the term block may refer to a macroblock in AVC, a macroblock or sub-block in VP8, a superblock or sub-block in VP9, or a superblock or sub-block in AV1.

In intra prediction, samples of a block to be encoded (also referred to as the current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted by projecting the position of the sample in the current block in a given direction (also referred to as an intra prediction mode) to a point along the reference samples. The sample may be predicted by interpolating between the two closest reference samples of the projection point if the projection does not fall directly on a reference sample. A prediction error (also referred to as a residual) may be determined for the current block based on differences between the predicted sample values and the original sample values of the current block.

At an encoder, this process of predicting samples and determining a prediction error based on a difference between the predicted samples and original samples may be performed for a plurality of different intra prediction modes, including non-directional intra prediction modes. The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block using the intra prediction mode indicated by the encoder and combining the predicted samples with the prediction error.

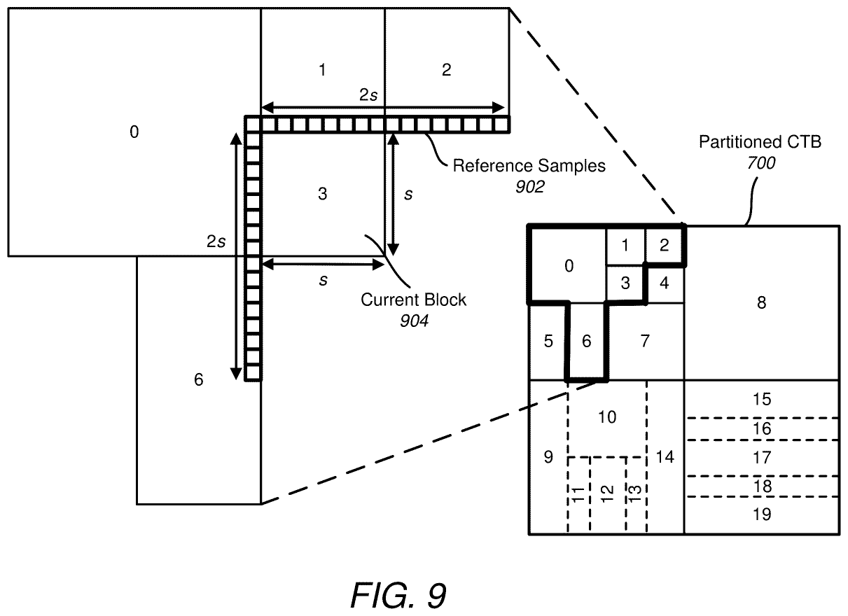

FIG. 9 illustrates an example set of reference samples 902 determined for intra prediction of a current block 904 being encoded or decoded. In FIG. 9, current block 904 corresponds to block 3 of partitioned CTB 700 in FIG. 7. As explained above, the numeric labels 0-19 of the blocks of partitioned CTB 700 may correspond to the sequence order for encoding/decoding the blocks and are used as such in the example of FIG. 9.

Given current block 904 is of w×h samples in size, reference samples 902 may extend over 2w samples of the row immediately adjacent to the top-most row of current block 904, 2h samples of the column immediately adjacent to the left-most column of current block 904, and the top left neighboring corner sample to current block 904. In the example of FIG. 9, current block 904 is square, so w=h=s. For constructing the set of reference samples 902, available samples from neighboring blocks of current block 904 may be used. Samples may not be available for constructing the set of reference samples 902 if, for example, the samples would lie outside the picture of the current block, the samples are part of a different slice of the current block (where the concept of slices are used), and/or the samples belong to blocks that have been inter coded and constrained intra prediction is indicated. When constrained intra prediction is indicated, intra prediction may not be dependent on inter predicted blocks.

In addition to the above, samples that may not be available for constructing the set of reference samples 902 include samples in blocks that have not already been encoded and reconstructed at an encoder or decoded at a decoder based on the sequence order for encoding/decoding. This restriction may allow identical prediction results to be determined at both the encoder and decoder. In FIG. 9, samples from neighboring blocks 0, 1, and 2 may be available to construct reference samples 902 given that these blocks are encoded and reconstructed at an encoder and decoded at a decoder prior to coding of current block 904. This assumes there are no other issues, such as those mentioned above, preventing the availability of samples from neighboring blocks 0, 1, and 2. However, the portion of reference samples 902 from neighboring block 6 may not be available due to the sequence order for encoding/decoding.

Unavailable ones of reference samples 902 may be filled with available ones of reference samples 902. For example, an unavailable reference sample may be filled with a nearest available reference sample determined by moving in a clock-wise direction through reference samples 902 from the position of the unavailable reference. If no reference samples are available, reference samples 902 may be filled with the mid-value of the dynamic range of the picture being coded.

It should be noted that reference samples 902 may be filtered based on the size of current block 904 being coded and an applied intra prediction mode. It should be further noted that FIG. 9 illustrates only one exemplary determination of reference samples for intra prediction of a block. In some proprietary and industry video coding standards, reference samples may be determined in a different manner than discussed above. For example, multiple reference lines may be used in other instances, such as used in VVC.

After reference samples 902 are determined and optionally filtered, samples of current block 904 may be intra predicted based on reference samples 902. Most encoders/decoders support a plurality of intra prediction modes in accordance with one or more video coding standards. For example, HEVC supports 35 intra prediction modes, including a planar mode, a DC mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture.

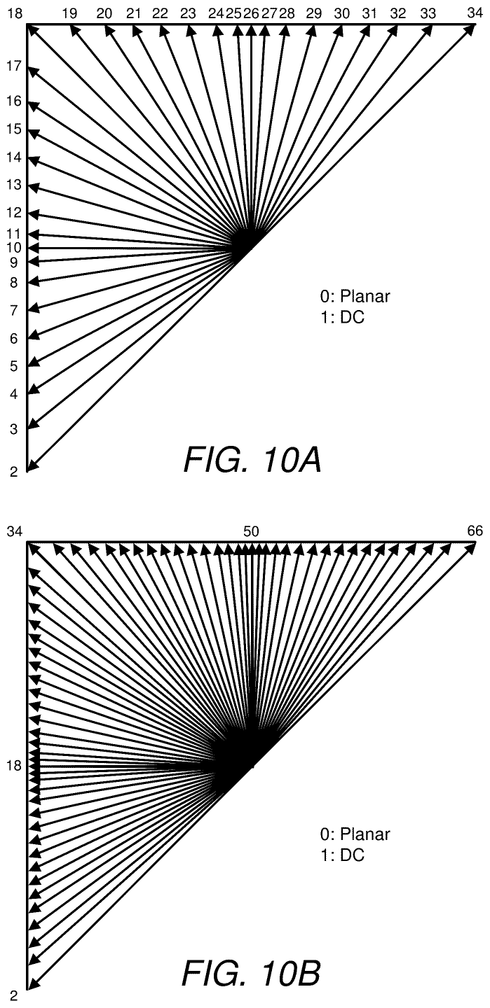

FIG. 10A illustrates the 35 intra prediction modes supported by HEVC. The 35 intra prediction modes are identified by indices 0 to 34. Prediction mode 0 corresponds to planar mode. Prediction mode 1 corresponds to DC mode. Prediction modes 2-34 correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B illustrates the 67 intra prediction modes supported by VVC. The 67 intra prediction modes are identified by indices 0 to 66. Prediction mode 0 corresponds to planar mode. Prediction mode 1 corresponds to DC mode. Prediction modes 2-66 correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction.

Because blocks in VVC may be non-square, some of the intra prediction modes illustrated in FIG. 10B may be adaptively replaced by wide-angle directions.

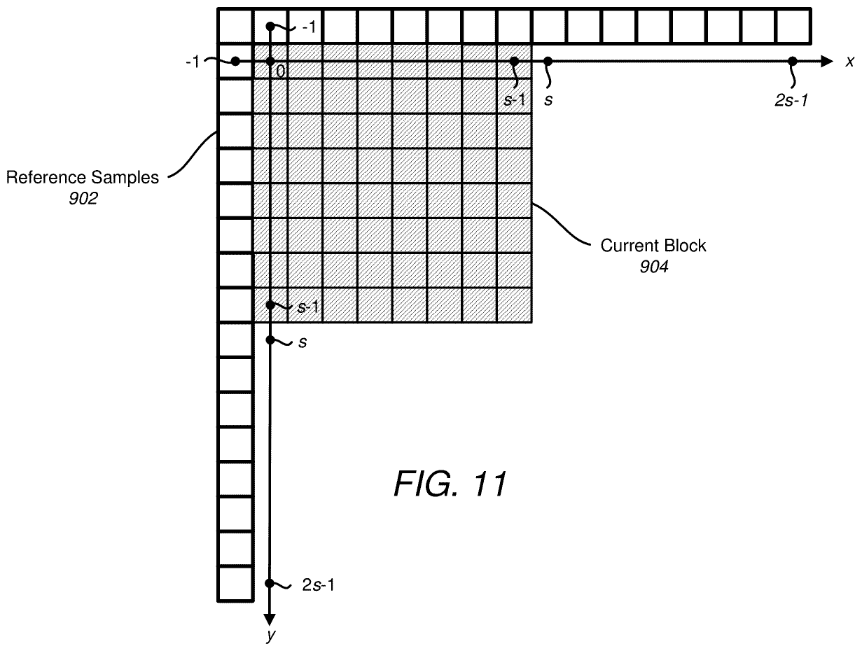

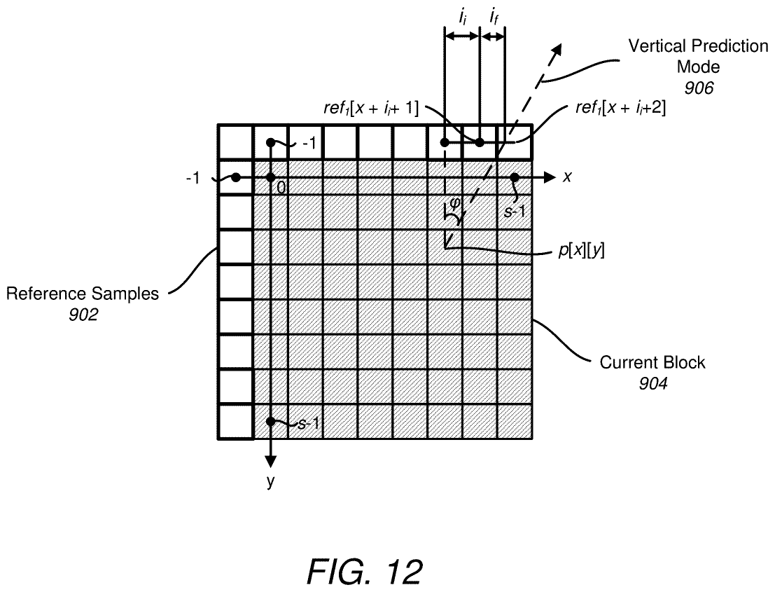

To further describe the application of intra prediction modes to determine a prediction of a current block, reference is made to FIGS. 11 and 12. In FIG. 11, current block 904 and reference samples 902 from FIG. 9 are shown in a two-dimensional x, y plane, where a sample may be referenced as p[x][y]. In order to simplify the prediction process, reference samples 902 may be placed in two, one-dimensional arrays. Reference samples 902 above current block 904 may be placed in the one-dimensional array ref₁[x]:

$${ref}_{1} [ x ] = p [ - 1 + x ] [ - 1 ] , ( x \geq 0 ) \qquad ( 1 )$$

Reference samples 902 to the left of current block 904 may be placed in the one-dimensional array ref₂[x]:

$${ref}_{2} [ y ] = p [ - 1 ] [ - 1 + y ] , ( y \geq 0 ) \qquad ( 2 )$$

For planar mode, a sample at location [x][y] in current block 904 may be predicted by calculating the mean of two interpolated values. The first of the two interpolated values may be based on a horizontal linear interpolation at location [x][y] in current block 904. The second of the two interpolated values may be based on a vertical linear interpolation at location [x][y] in current block 904. The predicted sample p[x][y] in current block 904 may be calculated as

$$p [ x ] [ y ] = \frac{1}{2 \cdot s} ( h [ x ] [ y ] + v [ x ] [ y ] + s ) \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizontal linear interpolation at location [x][y] in current block 904 and

$$v [ x ] [ y ] = ( s - y - 1 ) \cdot {ref}_{1} [ x ] + ( y + 1 ) \cdot {ref}_{2} [ s ] \qquad ( 5 )$$

may be the vertical linear interpolation at location [x][y] in current block 904.

For DC mode, a sample at location [x][y] in current block 904 may be predicted by the mean of the reference samples 902. The predicted value sample p[x][y] in current block 904 may be calculated as

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) \qquad ( 6 )$$

For angular modes, a sample at location [x][y] in current block 904 may be predicted by projecting the location [x][y] in a direction specified by a given angular mode to a point on the horizontal or vertical line of samples comprising reference samples 902. The sample at location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC) and relative to the x-axis for horizontal prediction modes (e.g., modes 2-18 in HEVC and modes 2-34 in VVC).

FIG. 12 illustrates a prediction of a sample at location [x][y] in current block 904 for a vertical prediction mode 906 given by an angle φ. For vertical prediction modes, the location [x][y] in current block 904 is projected to a point (referred to herein as the “projection point”) on the horizontal line of reference samples ref₁[x]. Reference samples 902 are only partially shown in FIG. 12 for ease of illustration. Because the projection point falls at a fractional sample position between two reference samples in the example of FIG. 12, the predicted sample p[x][y] in current block 904 may be calculated by linearly interpolating between the two reference samples as follows

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] \qquad ( 7 )$$

where i_{□} is the integer part of the horizontal displacement of the projection point relative to the location [x][y] and may calculated as a function of the tangent of the angle T of the vertical prediction mode 906 as follows

$${i}_{𝕀} = ⌊ ( y + 1 ) \cdot tan φ ⌋ , \qquad ( 8 )$$

and i_{f} is the fractional part of the horizontal displacement of the projection point relative to the location [x][y] and may be calculated as

$${i}_{f} = ( ( y + 1 ) \cdot tan φ ) - ⌊ ( y + 1 ) \cdot tan φ ⌋ . \qquad ( 9 )$$

where └⋅┘ is the integer floor.

For horizontal prediction modes, the position [x][y] of a sample in current block 904 may be projected onto the vertical line of reference samples ref₂[y]. Sample prediction for horizontal prediction modes is given by:

$$p [ x ] [ y ] = ( 1 - {i}_{f} ) \cdot {ref}_{2} [ y + {i}_{i} + 1 ] + {i}_{f} \cdot {ref}_{2} [ y + {i}_{i} + 2 ] \qquad ( 10 )$$

where i_{□} is the integer part of the vertical displacement of the projection point relative to the location [x][y] and may be calculated as a function of the tangent of the angle φ of the horizontal prediction mode as follows

$${i}_{𝕀} = ⌊ ( x + 1 ) \cdot tan φ ⌋ , \qquad ( 11 )$$

and i_{f} is the fractional part of the vertical displacement of the projection point relative to the location [x][y] and may be calculated as

$${i}_{𝕀} = ( ( x + 1 ) \cdot tan φ ) - ⌊ ( x + 1 ) \cdot tan φ ⌋ . \qquad ( 12 )$$

where └⋅┘ is the integer floor.

The interpolation functions of (7) and (10) may be implemented by an encoder or decoder, such as encoder 200 in FIG. 2 or decoder 300 in FIG. 3, as a set of two-tap finite impulse response (FIR) filters. The coefficients of the two-tap FIR filters may be respectively given by (1−i_{f}) and i_{f}. In the above angular intra prediction examples, the predicted sample p[x][y] may be calculated with some predefined level of sample accuracy, such as 1/32 sample accuracy. For 1/32 sample accuracy, the set of two-tap FIR interpolation filters may comprise up to 32 different two-tap FIR interpolation filters—one for each of the 32 possible values of the fractional part of the projected displacement i_{f}. In other examples, different levels of sample accuracy may be used.

In an embodiment, the two-tap interpolation FIR filter may be used for predicting chroma samples. For luma samples, a different interpolation technique may be used. For example, for luma samples a four-tap FIR filter may be used to determine a predicted value of a luma sample. For example, the four tap FIR filter may have coefficients determined based on i_{f}, similar to the two-tap FIR filter. For 1/32 sample accuracy, a set of 32 different four-tap FIR filters may comprise up to 32 different four-tap FIR filters—one for each of the 32 possible values of the fractional part of the projected displacement i_{f}. In other examples, different levels of sample accuracy may be used. The set of four-tap FIR filters may be stored in a look-up table (LUT) and referenced based on i_{f}. The value of the predicted sample p[x][y], for vertical prediction modes, may be determined based on the four-tap FIR filter as follows:

$$p [ x ] [ y ] = {\sum }_{𝕀 = 0}^{3} fT [ i ] * ref [ x + ildx + i ] \qquad ( 13 )$$

where ft[i], i=0 . . . 0.3, are the filter coefficients. The value of the predicted sample p[x][y] modes, for horizontal prediction modes, may be determined based on the four-tap FIR filter as follows:

$$p [ x ] [ y ] = {\sum }_{𝕀 = 0}^{3} fT [ i ] * ref [ y + ildx + i ] . \qquad ( 14 )$$

It should be noted that supplementary reference samples may be constructed for the case where the position [x][y] of a sample in current block 904 to be predicted is projected to a negative x coordinate, which happens with negative vertical prediction angles φ. The supplementary reference samples may be constructed by projecting the reference samples in ref₂ [y] in the vertical line of reference samples 902 to the horizontal line of reference samples 902 using the negative vertical prediction angle φ. Supplemental reference samples may be similarly for the case where the position [x][y] of a sample in current block 904 to be predicted is projected to a negative y coordinate, which happens with negative horizontal prediction angles φ. The supplementary reference samples may be constructed by projecting the reference samples in ref₁ [x] on the horizontal line of reference samples 902 to the vertical line of reference samples 902 using the negative horizontal prediction angle φ.

An encoder may predict the samples of a current block being encoded, such as current block 904, for a plurality of intra prediction modes as explained above. For example, the encoder may predict the samples of the current block for each of the 35 intra prediction modes in HEVC or 67 intra prediction modes in VVC. For each intra prediction mode applied, the encoder may determine a prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may select one of the intra prediction modes to encode the current block based on the determined prediction errors. For example, the encoder may select an intra prediction mode that results in the smallest prediction error for the current block. In another example, the encoder may select the intra prediction mode to encode the current block based on a rate-distortion measure (e.g., Lagrangian rate-distortion cost) determined using the prediction errors. The encoder may send an indication of the selected intra prediction mode and its corresponding prediction error to a decoder for decoding of the current block.

Similar to an encoder, a decoder may predict the samples of a current block being decoded, such as current block 904, for an intra prediction modes as explained above. For example, the decoder may receive an indication of an angular intra prediction mode from an encoder for a block. The decoder may construct a set of reference samples and perform intra prediction based on the angular intra prediction mode indicated by the encoder for the block in a similar manner as discussed above for the encoder. The decoder would add the predicted values of the samples of the block to a residual of the block to reconstruct the block. In another embodiment, the decoder may not receive an indication of an angular intra prediction mode from an encoder for a block. Instead, the decoder may determine an intra prediction mode through other, decoder-side means.

Although the description above was primarily made with respect to intra prediction modes in HEVC and VVC, it will be understood that the techniques of the present disclosure described above and further below may be applied to other intra prediction modes, including those of other video coding standards like VP8, VP9, AV1, and the like.

As explained above, intra prediction may exploit correlations between spatially neighboring samples in the same picture of a video sequence to perform video compression. Inter prediction is another coding tool that may be used to exploit correlations in the time domain between blocks of samples in different pictures of the video sequence to perform video compression. In general, an object may be seen across multiple pictures of a video sequence. The object may move (e.g., by some translation and/or affine motion) or remain stationary across the multiple pictures. A current block of samples in a current picture being encoded may therefore have a corresponding block of samples in a previously decoded picture that accurately predicts the current block of samples. The corresponding block of samples may be displaced from the current block of samples due to movement of an object, represented in both blocks, across the respective pictures of the blocks. The previously decoded picture may be referred to as a reference picture and the corresponding block of samples in the reference picture may be referred to as a reference block or motion compensated prediction. An encoder may use a block matching technique to estimate the displacement (or motion) and determine the reference block in the reference picture.

Similar to intra prediction, once a prediction for a current block is determined and/or generated using inter prediction, an encoder may determine a difference between the current block and the prediction. The difference may be referred to as a prediction error or residual. The encoder may then store and/or signal in a bitstream the prediction error and other related prediction information for decoding or other forms of consumption. A decoder may decode the current block by predicting the samples of the current block using the prediction information and combining the predicted samples with the prediction error.

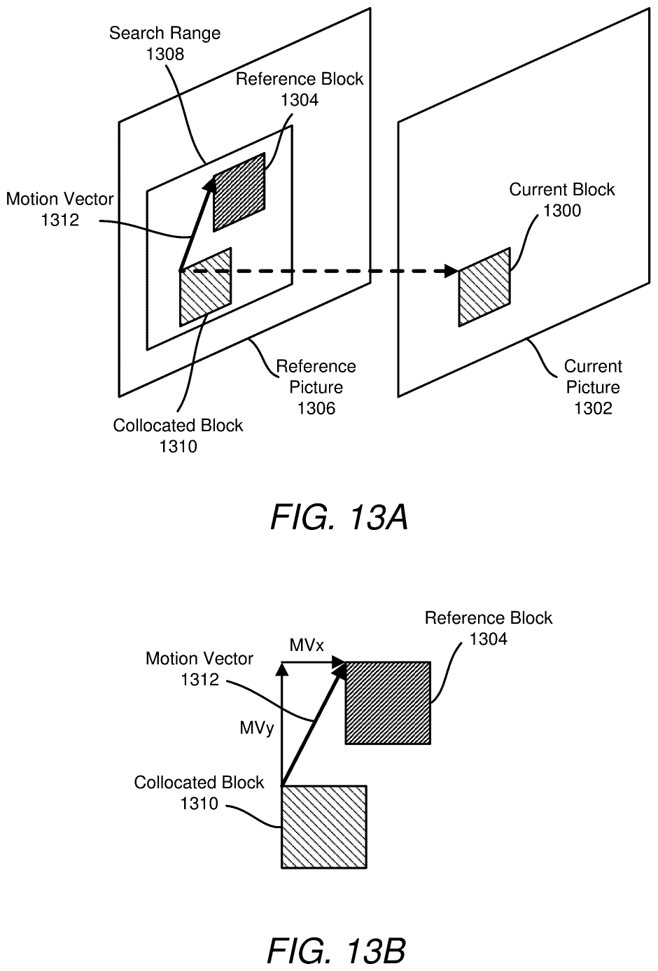

FIG. 13A illustrates an example of inter prediction performed for a current block 1300 in a current picture 1302 being encoded. An encoder, such as encoder 200 in FIG. 2, may perform inter prediction to determine and/or generate a reference block 1304 in a reference picture 1306 to predict current block 1300. Reference pictures, like reference picture 1306, are prior decoded pictures available at the encoder and decoder. Availability of a prior decoded picture may depend on whether the prior decoded picture is available in a decoded picture buffer at the time current block 1300 is being encoded or decoded. The encoder may, for example, search one or more reference pictures for a reference block that is similar to current block 1300. The encoder may determine a “best matching” reference block from the blocks tested during the searching process as reference block 1304. The encoder may determine that reference block 1304 is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), or sum of absolute transformed differences (SATD)) between the prediction samples of reference block 1304 and the original samples of current block 1300.

The encoder may search for reference block 1304 within a search range 1308. Search range 1308 may be positioned around the collocated position (or block) 1310 of current block 1300 in reference picture 1306. In some instances, search range 1308 may at least partially extend outside of reference picture 1306. When extending outside of reference picture 1306, constant boundary extension may be used such that the values of the samples in the row or column of reference picture 1306, immediately adjacent to the portion of search range 1308 extending outside of reference picture 1306, are used for the “sample” locations outside of reference picture 1306. All or a subset of potential positions within search range 1308 may be searched for reference block 1304. The encoder may utilize any one of a number of different search implementations to determine and/or generate reference block 1304. For example, the encoder may determine a set of a candidate search positions based on motion information of neighboring blocks to current block 1300.

One or more reference pictures may be searched by the encoder during inter prediction to determine and/or generate the best matching reference block. The reference pictures searched by the encoder may be included in one or more reference picture lists. For example, in HEVC and VVC, two reference picture lists may be used, a reference picture list 0 and a reference picture list 1. A reference picture list may include one or more pictures. Reference picture 1306 of reference block 1304 may be indicated by a reference index pointing into a reference picture list comprising reference picture 1306.

The displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVₓ) and a vertical component (MV_{y}) relative to the position of current block 1300. FIG. 13B illustrates the horizontal component and vertical component of motion vector 1312. A motion vector, such as motion vector 1312, may have fractional or integer resolution. A motion vector with fractional resolution may point between two samples in a reference picture to provide a better estimation of the motion of current block 1300. For example, a motion vector may have ½, ¼, ⅛, 1/16, or 1/32 fractional sample resolution. When a motion vector points to a non-integer sample value in the reference picture, interpolation between samples at integer positions may be used to generate the reference block and its corresponding samples at fractional positions. The interpolation may be performed by a filter with two or more taps.

Once reference block 1304 is determined and/or generated for current block 1300 using inter prediction, the encoder may determine a difference (e.g., a corresponding sample-by-sample difference) between reference block 1304 and current block 1300. The difference may be referred to as a prediction error or residual. The encoder may then store and/or signal in a bitstream the prediction error and the related motion information for decoding or other forms of consumption. The motion information may include motion vector 1312 and a reference index pointing into a reference picture list comprising reference picture 1306. In other instances, the motion information may include an indication of motion vector 1312 and an indication of the reference index pointing into the reference picture list comprising reference picture 1306. A decoder may decode current block 1300 by determining and/or generating reference block 1304, which forms the prediction of current block 1300, using the motion information and combining the prediction with the prediction error.

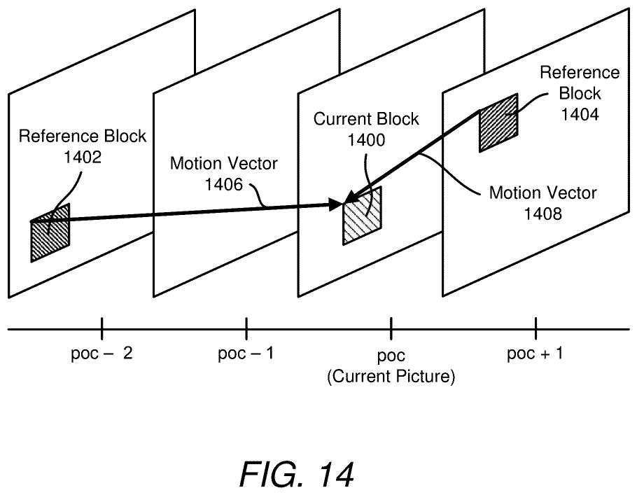

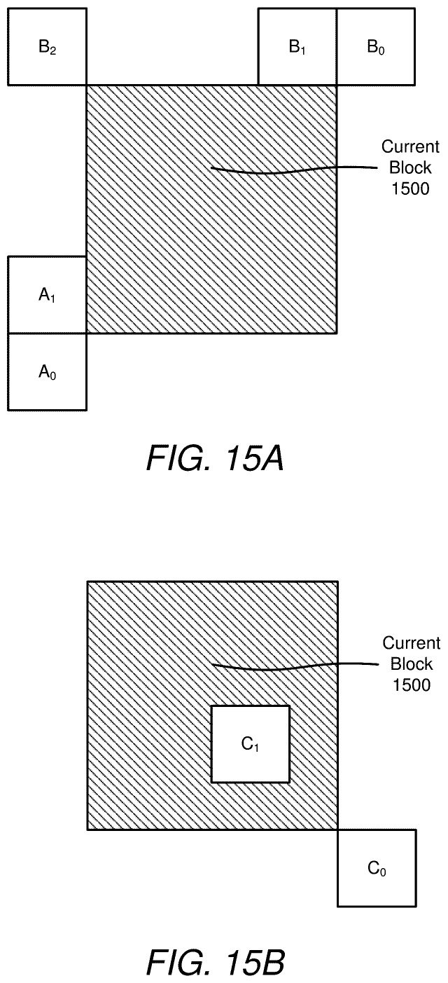

In FIG. 13A, inter prediction is performed using one reference picture 1306 as the source of the prediction for current block 1300. Because the prediction for current block 1300 comes from a single picture, this type of inter prediction is referred to as uni-prediction. FIG. 14 illustrates another type of inter prediction, referred to as bi-prediction, performed for a current block 1400. In bi-prediction, the source of the prediction for a current block 1400 comes from two pictures. Bi-prediction may be useful, for example, where the video sequence comprises fast motion, camera panning or zooming, or scene changes. Bi-prediction may also be useful to capture fade outs of one scene or fade outs from one scene to another, where two pictures are effectively displayed simultaneously with different levels of intensity.

Whether uni-prediction or both uni-prediction and bi-prediction are available for performing inter prediction may depend on a slice type of current block 1400. For P slices, only uni-prediction may be available for performing inter prediction. For B slices, either uni-prediction or bi-prediction may be used. When uni-prediction is performed, an encoder may determine and/or generate a reference block for predicting current block 1400 from reference picture list 0. When bi-prediction is performed, an encoder may determine and/or generate a first reference block for predicting current block 1400 from reference picture list 0 and determine and/or generate a second reference block for predicting current block 1400 from reference picture list 1.

In FIG. 14, inter-prediction is performed using bi-prediction, where two reference blocks 1402 and 1404 are used to predict current block 1400. Reference block 1402 may be in a reference picture of one of reference picture list 0 or 1, and reference block 1404 may be in a reference picture of the other one of reference picture list 0 or 1. As shown in FIG. 14, reference block 1402 is in a picture that precedes the current picture of current block 1400 in terms of picture order count (POC), and reference block 1402 is in a picture that proceeds the current picture of current block 1400 in terms of POC. In other examples, the reference pictures may both precede or proceed the current picture in terms of POC. POC is the order in which pictures are output from, for example, a decoded picture buffer and is the order in which pictures are generally intended to be displayed. However, it should be noted that pictures that are output are not necessarily displayed but may undergo different processing or consumption, such as transcoding. In other examples, the two reference blocks determined and/or generated using bi-prediction may come from the same reference picture. In such an instance, the reference picture may be included in both reference picture list 0 and reference picture list 1.

A configurable weight and offset value may be applied to the one or more inter prediction reference blocks. An encoder may enable the use of weighted prediction using a flag in a picture parameter set (PPS) and signal the weighting and offset parameters in the slice segment header for the current block. Different weight and offset parameters may be signaled for luma and chroma components.

Once reference blocks 1402 and 1404 are determined and/or generated for current block 1400 using inter prediction, the encoder may determine a difference between current block 1400 and each of reference blocks 1402 and 1404. The differences may be referred to as prediction errors or residuals. The encoder may then store and/or signal in a bitstream the prediction errors and their respective related motion information for decoding or other forms of consumption. The motion information for reference block 1402 may include motion vector 1406 and the reference index pointing into the reference picture list comprising the reference picture of reference block 1402. In other instances, the motion information for reference block 1402 may include an indication of motion vector 1406 and an indication of the reference index pointing into the reference picture list comprising reference picture of reference block 1402. The motion information for reference block 1404 may include motion vector 1408 and the reference index pointing into the reference picture list comprising the reference picture of reference block 1404. In other instances, the motion information for reference block 1404 may include an indication of motion vector 1408 and an indication of the reference index pointing into the reference picture list comprising reference picture of reference block 1404. A decoder may decode current block 1400 by determining and/or generating reference blocks 1402 and 1404, which together form the prediction of current block 1400, using their respective motion information and combining the predictions with the prediction errors.

In HEVC, VVC, and other video compression schemes, motion information may be predictively coded before being stored or signaled in a bit stream. The motion information for a current block may be predictively coded based on the motion information of neighboring blocks of the current block. In general, the motion information of the neighboring blocks is often correlated with the motion information of the current block because the motion of an object represented in the current block is often the same or similar to the motion of objects in the neighboring blocks. Two of the motion information prediction techniques in HEVC and VVC include advanced motion vector prediction (AMVP) and inter prediction block merging.

An encoder, such as encoder 200 in FIG. 2, may code a motion vector using the AMVP tool as a difference between the motion vector of a current block being coded and a motion vector predictor (MVP). An encoder may select the MVP from a list of candidate MVPs. The candidate MVPs may come from previously decoded motion vectors of neighboring blocks in the current picture of the current block or blocks at or near the collocated position of the current block in other reference pictures. Both the encoder and decoder may generate or determine the list of candidate MVPs.

After the encoder selects an MVP from the list of candidate MVPs, the encoder may signal, in a bitstream, an indication of the selected MVP and a motion vector difference (MVD). The encoder may indicate the selected MVP in the bitstream by an index pointing into the list of candidate MVPs. The MVD may be calculated based on the difference between the motion vector of the current block and the selected MVP. For example, for a motion vector represented by a horizontal component (MVₓ) and a vertical displacement (MV_{y}) relative to the position of the current block being coded, the MVD may be represented by two components calculated as follows:

$${MVD}_{x} = {MV}_{x} - {MVP}_{x} \qquad ( 15 )$$

$${MVD}_{y} = {MV}_{y} - {MVP}_{y} \qquad ( 16 )$$

where MVDₓ and MVD_{y} respectively represent the horizontal and vertical components of the MVD, and MVPₓ and MVP_{y} respectively represent the horizontal and vertical components of the MVP. A decoder, such as decoder 300 in FIG. 3, may decode the motion vector by adding the MVD to the MVP indicated in the bitstream. The decoder may then decode the current block by determining and/or generating the reference block, which forms the prediction of the current block, using the decoded motion vector and combining the prediction with the prediction error.

In HEVC and VVC, the list of candidate MVPs for AMVP may comprise two candidates referred to as candidates A and B. Candidates A and B may include up to two spatial candidate MVPs derived from five spatial neighboring blocks of the current block being coded, one temporal candidate MVP derived from two temporal, co-located blocks when both spatial candidate MVPs are not available or are identical, or zero motion vectors when the spatial, temporal, or both candidates are not available. FIG. 15A illustrates the location of the five spatial candidate neighboring blocks relative to a current block 1500 being encoded. The five spatial candidate neighboring blocks are respectively denoted A₀, A₁, B₀, B₁, and B₂. FIG. 15B illustrates the location of the two temporal, co-located blocks relative to current block 1500 being coded. The two temporal, co-located blocks are denoted C₀ and C₁ and are included in a reference picture that is different from the current picture of current block 1500.

An encoder, such as encoder 200 in FIG. 2, may code a motion vector using the inter prediction block merging tool also referred to as merge mode. Using merge mode, the encoder may reuse the same motion information of a neighboring block for inter prediction of a current block. Because the same motion information of a neighboring block is used, no MVD needs to be signaled and the signaling overhead for signaling the motion information of the current block may be small in size. Similar to AMVP, both the encoder and decoder may generate a candidate list of motion information from neighboring blocks of the current block. The encoder may then determine to use (or inherit) the motion information of one neighboring block's motion information in the candidate list for predicting the motion information of the current block being coded. The encoder may signal, in the bit stream, an indication of the determined motion information from the candidate list. For example, the encoder may signal an index pointing into the list of candidate motion information to indicate the determined motion information.

In HEVC and VVC, the list of candidate motion information for merge mode may comprise up to four spatial merge candidates that are derived from the five spatial neighboring blocks used in AMVP as shown in FIG. 15A, one temporal merge candidate derived from two temporal, co-located blocks used in AMVP as shown in FIG. 15B, and additional merge candidates including bi-predictive candidates and zero motion vector candidates.

It should be noted that inter prediction may be performed in other ways and variants than those described above. For example, motion information prediction techniques other than AMVP and merge mode are possible. In addition, although the description above was primarily made with respect to inter prediction modes in HEVC and VVC, it will be understood that the techniques of the present disclosure described above and further below may be applied to other inter prediction modes, including those of other video coding standards like VP8, VP9, AV1, and the like. In addition, history based motion vector prediction (HMVP), combined intra/inter prediction mode (CIIP), and merge mode with motion vector difference (MMVD) as described in VVC may also be performed and are within the scope of the present disclosure.

In inter prediction, a block matching technique may be applied to determine a reference block in a different picture than the current block being encoded. Block matching techniques have also been applied to determine a reference block in the same picture as a current block being encoded. However, it has been determined that for camera-captured videos, a reference block in the same picture as the current block determined using block matching may often not accurately predict the current block. For screen content video this is generally not the case. Screen content video may include, for example, computer generated text, graphics, and animation. Within screen content, there is often repeated patterns (e.g., repeated patterns of text and graphics) within the same picture. Therefore, a block matching technique applied to determine a reference block in the same picture as a current block being encoded may provide efficient compression for screen content video.

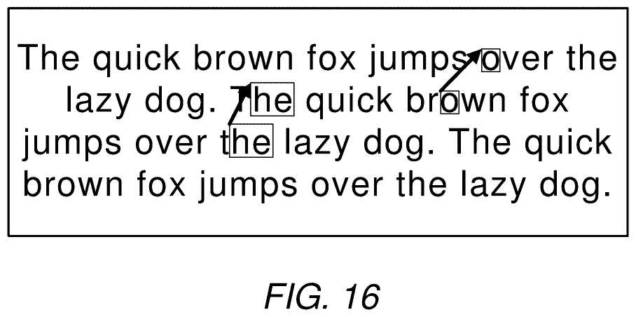

HEVC and VVC both include a prediction technique to exploit the correlation between blocks of samples within the same picture of screen content video. This technique is referred to as intra block (IBC) or current picture referencing (CPR). Similar to inter prediction, an encoder may apply a block matching technique to determine a displacement vector (referred to as a block vector (BV)) that indicates the relative displacement from the current block to a reference block (or intra block compensated prediction) that “best matches” the current block. The encoder may determine the best matching reference block from blocks tested during a searching process similar to inter prediction. The encoder may determine that a reference block is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), sum of absolute transformed differences (SATD), or difference determined based on a hash function) between the prediction samples of the reference block and the original samples of the current block. A reference block may correspond to prior decoded blocks of samples of the current picture. The reference block may comprise decoded blocks of samples of the current picture prior to being processed by in-loop filtering operations, like deblocking or SAO filtering. FIG. 16 illustrates an example of IBC applied for screen content. The rectangular portions with arrows beginning at their boundaries are current blocks being encoded and the rectangular portions that the arrows point to are the reference blocks for predicting the current blocks.

Once a reference block is determined and/or generated for a current block using IBC, the encoder may determine a difference (e.g., a corresponding sample-by-sample difference) between the reference block and the current block. The difference may be referred to as a prediction error or residual. The encoder may then store and/or signal in a bitstream the prediction error and the related prediction information for decoding or other forms of consumption. The prediction information may include a BV. In other instances, the prediction information may include an indication of the BV. A decoder, such as decoder 300 in FIG. 3, may decode the current block by determining and/or generating the reference block, which forms the prediction of the current block, using the prediction information and combining the prediction with the prediction error.

In HEVC, VVC, and other video compression schemes, a BV may be predictively coded before being stored or signaled in a bit stream. The BV for a current block may be predictively coded based on the BV of neighboring blocks of the current block. For example, an encoder may predictively code a BV using the merge mode as explained above for inter prediction or a similar technique as AMVP also explained above for inter prediction. The technique similar to AMVP may be referred to as BV prediction and difference coding.

For BV prediction and difference coding, an encoder, such as encoder 200 in FIG. 2, may code a BV as a difference between the BV of a current block being coded and a BV predictor (BVP). An encoder may select the BVP from a list of candidate BVPs. The candidate BVPs may come from previously decoded BVs of neighboring blocks of the current block in the current picture. Both the encoder and decoder may generate or determine the list of candidate BVPs.

After the encoder selects a BVP from the list of candidate BVPs, the encoder may signal, in a bitstream, an indication of the selected BVP and a BV difference (BVD). The encoder may indicate the selected BVP in the bitstream by an index pointing into the list of candidate BVPs. The BVD may be calculated based on the difference between the BV of the current block and the selected BVP. For example, for a BV represented by a horizontal component (BVₓ) and a vertical component (BV_{y}) relative to the position of the current block being coded, the BVD may represented by two components calculated as follows:

$${BVD}_{x} = {BV}_{x} - {BVP}_{x} \qquad ( 17 )$$

$${BVD}_{y} = {BV}_{y} - {BVP}_{y} \qquad ( 18 )$$

where BVDₓ and BVD_{y} respectively represent the horizontal and vertical components of the BVD, and BVPₓ and BVP_{y} respectively represent the horizontal and vertical components of the BVP. A decoder, such as decoder 300 in FIG. 3, may decode the BV by adding the BVD to the BVP indicated in the bitstream. The decoder may then decode the current block by determining and/or generating the reference block, which forms the prediction of the current block, using the decoded BV and combining the prediction with the prediction error.

In HEVC and VVC, the list of candidate BVPs may comprise two candidates referred to as candidates A and B. Candidates A and B may include up to two spatial candidate BVPs derived from five spatial neighboring blocks of the current block being encoded, or one or more of the last two coded BVs when spatial neighboring candidates are not available (e.g., because they are coded in intra or inter mode). The location of the five spatial candidate neighboring blocks relative to a current block being encoded using IBC are the same as those shown in FIG. 15A for inter prediction. The five spatial candidate neighboring blocks are respectively denoted A₀, A₁, B₀, B₁, and B₂.

A current block may be predicted by a prediction block using an intra prediction mode called template matching prediction (TMP). In TMP, a reference region is searched for a prediction block template that matches a current block template. The prediction block referenced by the prediction block template is used to predict the current block.

TMP may be used in intra prediction to predict similar elements within a given picture (or frame), for example, by using previously coded content elements to predict similar content elements that reoccur in subsequent blocks to be coded. In camera-captured content, similar content elements in a given picture (or frame) may be reoccurring textures. In screen-captured content, similar content elements in a given picture (or frame) may be reoccurring characters, graphics, or user interfaces.

TMP exploits correlations, or similarities, between portions of content in a frame or picture to predict a current block. For example, when blocks are similar to each other, the templates of the blocks are more likely to be similar to each other. In another example, blocks having similar templates are more likely to be similar to each other than blocks having dissimilar templates.

TMP may also employ averaging techniques. For example, an average of a plurality of prediction candidates may be used to predict a current block. Averaging a plurality of template matching prediction candidates may increase the accuracy of a prediction of a current block compared to using a single candidate for prediction of the same current block.

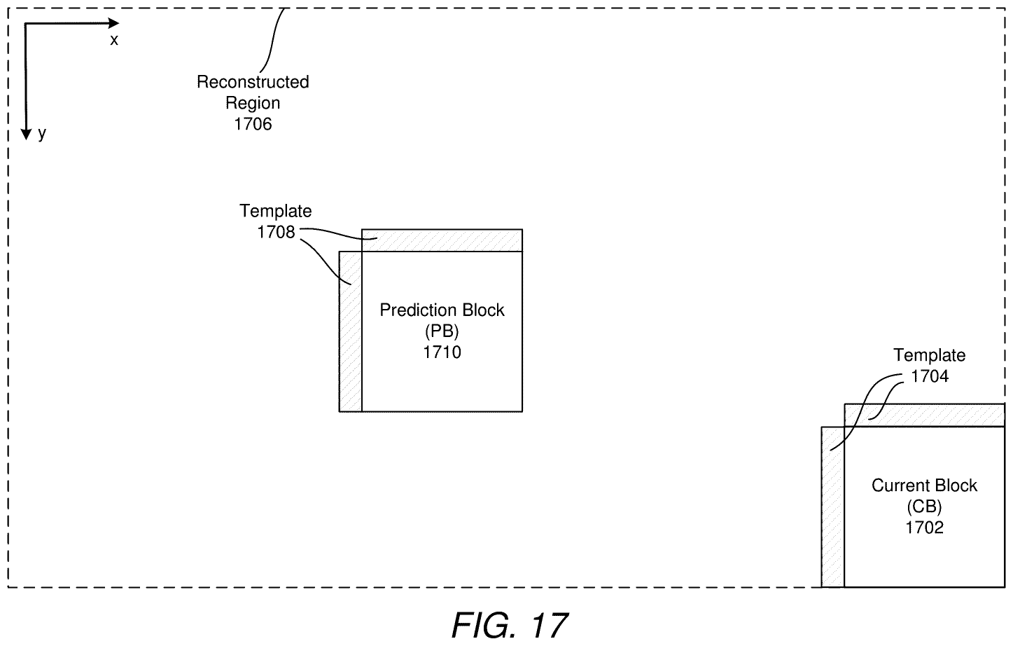

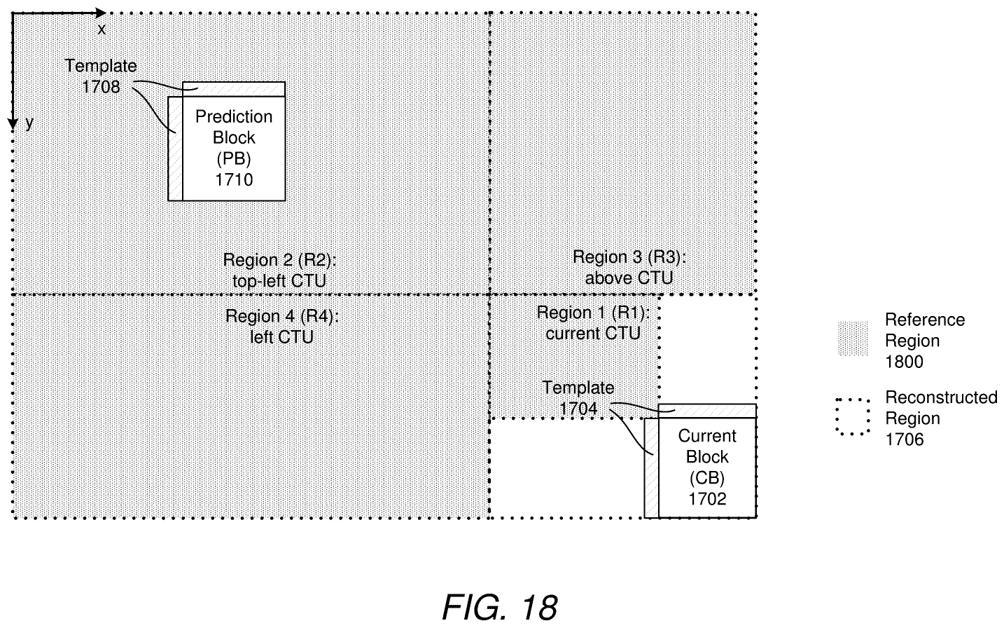

FIG. 17 illustrates an example of template matching prediction (TMP) for predicting a current block (CB) 1702. CB 1702 comprises a rectangular block of samples to be encoded by an encoder. The samples of CB 1702 are arranged in columns and rows.

To perform TMP for predicting CB 1702, an encoder may determine or construct a template 1704 of CB 1702. The encoder may determine or construct template 1704 based on samples in a reconstructed region 1706. Reconstructed region 1706 comprises reconstructed samples. A reconstructed sample is a sample that has been encoded and decoded. Reconstructed samples may differ from the corresponding original samples of a picture or frame because the encoding and decoding process may comprise a lossy process that loses information (e.g., a quantization process following transformation).

In an example, template 1704 may comprise samples in reconstructed region 1706 that are adjacent to the samples of CB 1702. For example, template 1704 may comprise samples in reconstructed region 1706 to the left and/or above CB 1702. In an example, template 1704 may comprise samples in reconstructed region 1706 from the column of samples directly adjacent to the left-most column of samples of CB 1702 and/or samples from the row of samples directly adjacent to the top-most row of samples of CB 1702. In another example, template 1704 may comprise samples in reconstructed region 1706 from a column of samples to the left of, but not directly adjacent to, the left-most column of samples of CB 1702 and/or samples from the row of samples above, but not directly adjacent to, the top-most row of samples of CB 1702.

When template 1704 comprises samples in reconstructed region 1706 from both a column (or columns) of samples to the left of the left-most column of samples of CB 1702 and from a row (or rows) of samples above the top-most row of samples of CB 1702, template 1704 may have the shape of an “L” that is rotated clockwise by 90 degrees. In the example of FIG. 17, template 1704 has this rotated L-shape but does not include the sample(s) at the intersection of the top (or above) and left samples. In another example, template 1704 may comprise the sample(s) at the intersection of the top (or above) and left samples.

After determining or constructing template 1704, the encoder may search reconstructed region 1706 for a template of a prediction block (PB) that is determined to “best” match template 1704 of CB 1702. The encoder may search reconstructed region 1706 for a template of a PB that “best” matches template 1704 by determining a cost between template 1704 of CB 1702 and one or more templates of one or more PBs in reconstructed region 1706. The templates of the PBs, e.g., a template 1708 of a PB 1710, may be of the same shape and size as template 1704 of CB 1702. In other examples, the templates of the PBs may have a different shape and/or size as template 1704 of CB 1702. In an example, the cost may be based on, for example, a difference (e.g., sum of squared differences (SSD), sum of absolute differences (SAD), sum of absolute transformed differences (SATD), or difference determined based on a hash function) between template 1708 of PB 1710 and template 1704 of CB 1702. In the example of FIG. 17, template 1708 of PB 1710 is determined to be the “best” match to template 1704 of CB 1702 (e.g., based on the cost between template 1704 and template 1708 being the smallest cost).

After determining template 1708 that “best” matches template 1704, the encoder may use PB 1710 of template 1708 to predict current block 1702. For example, the encoder may determine a difference (e.g., a corresponding sample-by-sample difference) between current block 1702 and prediction block 1710. The difference may be referred to as a prediction error or residual. The encoder may then store and/or signal in a bitstream the prediction error or residual for decoding by a decoder.

To perform TMP for predicting CB 1702, a decoder may perform the same operations as the encoder as described above with respect to FIG. 17. For example, based on receiving an indication from the encoder that TMP is used to predict CB 1702 (e.g., via a flag), the decoder may similarly determine or construct template 1704 of CB 1702. After determining or constructing template 1704, the decoder may further similarly search reconstructed region 1706 for a template of a PB that is determined to “best” match template 1704 of CB 1702. For example, the decoder may determine that template 1708 of PB 1710 is the “best” match to template 1704 of CB 1702. After determining template 1708 “best” matches template 1704, the decoder may use PB 1710 of template 1708 to predict CB 1702. The decoder may then add the residual, received from the encoder, to PB 1710 to reconstruct CB 1702.

FIG. 18 illustrates the same TMP as FIG. 17 but also illustrates an example reference region 1800. Reference region 1800 comprises a portion of reconstructed region 1706.

Reference region 1800 indicates the regions that the encoder or decoder may search for the “best” matching template for template 1704 of CB 1702. Reference region 1800 may include four coding tree units (CTUs). Relative to CB 1702, region 1 is the current CTU, region 2 is the top-left CTU, region 3 is the above CTU, and region 4 is the left CTU. The CTUs are a result of picture partitioning operations described in more detail above.

For example, an encoder or decoder may search for a “best” matching template within reference region 1800, i.e., within each of region 1, region 2, region 3, and region 4. For example, template 1708 may be determined to “best” match template 1704 of CB 1702 based on having a lowest SAD cost or some other cost as described above. The decoder may then use PB 1710 of template 1708 to predict CB 1702.

Further, in practice, the dimensions of reference region 1800 (referred to as SearchRange_w, SearchRange_h) may be set proportionally to the dimensions of CB 1702 (referred to as BlkW, BlkH), for example, in order to have a fixed number of SAD comparisons (or other difference comparisons) per pixel. More specifically, the dimensions of reference region 1800 may be calculated as follows:

$$SearchRange\_w = a * BlkW \qquad ( 19 )$$

$$SearchRange\_h = a * BlkH \qquad ( 20 )$$

Where ‘a’ (or alpha) is a constant that controls a gain/complexity trade-off for the encoder or decoder. In practice, ‘a’ may be equal to 5. In FIG. 18, it should further be noted that the dimensions of the regions of reference region 1800, as well as reconstructed region 1706, are illustrated by example and not by limitation. In practice, for example, the dimensions of the regions may vary, and one or more of the regions may not be present.

In this example, portions of reconstructed region 1802 directly above and directly left of CB 1804 may not be available for prediction and are thus excluded from reference region 1800. For example, this may be because a prediction block in these portions would overlap with CB 1702, which would be an invalid location for prediction of CB 1702. For example, CB 1702 itself is unavailable to the decoder for use in searching. This restriction may also be based on the unavailability of samples because of the sequence order of encoding or decoding.

Compared to IBC, TMP has the advantage of not requiring signaling of a block vector (BV) from the encoder to the decoder. A BV may indicate the displacement of a PB (e.g., PB 1710) relative to a CB (e.g., CB 1702). An encoder may construct and send a BV to a decoder to allow the decoder to locate the PB used to predict the CB. While using TMP, the encoder and decoder may perform the same search in the reconstructed region to determine the location of the “best” matching prediction block in the reconstructed region and therefore the encoder does not need to construct or send a BV to the decoder.

The problem with TMP is that even though a PB's template may be highly correlated with the CB's template, this correlation does not necessarily extend between the PB and the CB. In the instance where the correlation does not extend between the PB and the CB, the PB will not accurately predict the CB. Existing technologies do not offer a solution to improve the accuracy of the prediction of the CB without compromising (or fully compromising) the benefits of TMP, such as the reduction of signaling overhead by not requiring a BV to be signaled from the encoder to the decoder. For example, with existing technologies, it may be necessary to signal a BV to identify a PB that better predicts the CB, which would compromise the signaling overhead improvement associated with TMP.

Embodiments of the present disclosure are directed to performing TMP to determine a block vector predictor (BVP), or a candidate BVP, in order to determine a first prediction block (PB) for a current block (CB). In embodiments of the present disclosure, the prediction of the CB may be further refined using a block vector difference (BVD). The BVD may indicate the displacement of a second PB relative to the first PB. For example, “relative to” may mean that the location of the second PB is displaced by the BVD from the location of the first PB. In embodiments of the present disclosure, the second PB may be a more accurate prediction of the CB compared to the first PB determined using only TMP.

An embodiment of the present disclosure includes determining a BVP based on a template of a CB and a template of a first PB in a reference region. The embodiment further includes determining a block vector (BV) based on the BVP and a BVD. The embodiment further includes decoding the CB based on a second PB that is displaced from the CB by the BV in the reference region.

A further embodiment of the present disclosure includes determining a location of a first PB in a reference region based on a template of a CB and a template of the first PB. The embodiment further includes determining a location of a second PB based on the location of the first PB and a BVD. The embodiment further includes decoding the CB based on the second PB that is displaced from the first PB by the BVD in the reference region.

A further embodiment of the present disclosure includes determining a BVP based on a template of a CB and a template of a first PB in a reference region. The embodiment further includes determining a BVD between the first PB and a second PB. The embodiment further includes signaling an indication of the BVD in a bitstream.

A further embodiment of the present disclosure includes determining a location of a first PB in a reference region based on a template of a CB and a template of the first PB. The embodiment further includes determining a location of a second PB based on the location of the first PB and a BVD. The embodiment further includes signaling an indication of the BVD in a bitstream.

A further embodiment of the present disclosure includes determining a BVP based on a template of a CB and a template of a first PB in a reference region. The embodiment further includes, for each respective candidate BVD of one or more of a plurality of candidate BVDs, determining a cost of the candidate BVD based on a PB displaced from the first PB by the respective candidate BVD. The embodiment further includes signaling, in a bitstream, an indication of a selected candidate BVD from the one or more of the plurality of the candidate BVDs based on the costs.

A further embodiment of the present disclosure includes determining a location of a first PB in a reference region based on a template of a CB and a template of the first PB. The embodiment further includes, for each respective candidate BVD of one or more of a plurality of candidate BVDs, determining a cost of the candidate BVD based on a PB displaced from the location of the first PB by the respective candidate BVD. The embodiment further includes signaling, in a bitstream, an indication of a selected candidate BVD from the one or more of the plurality of the candidate BVDs based on the costs.

The displacement vector between a current block (CB) and a prediction block (PB) may be referred to as a block vector predictor (BVP). The BVP may indicate the displacement of a first PB relative to the CB. In an example, the encoder or decoder may not need to determine the BVP because the encoder or decoder determines the location of the first PB by TMP. Further, because the reconstructed region is already available to the encoder and decoder, there may be minimal signaling overhead for performing TMP within the reconstructed region. For example, it may only be necessary to signal a 1-bit flag indicating that TMP should be used for prediction. In practice, example encoder and decoder implementations may infer that TMP is to be used for prediction if no other type of intra prediction mode flag is signaled.

In embodiments of the present disclosure, the prediction of the CB may be further refined using a block vector difference (BVD). The BVD may indicate the displacement of a second PB relative to the first PB. The second PB may be a more accurate prediction of the CB. The encoder or decoder may determine that a PB is a more accurate PB, or the “best matching” PB, based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), sum of absolute transformed differences (SATD), or difference determined based on a hash function) between the PB and the CB.

These and other features of the present disclosure are described further below.

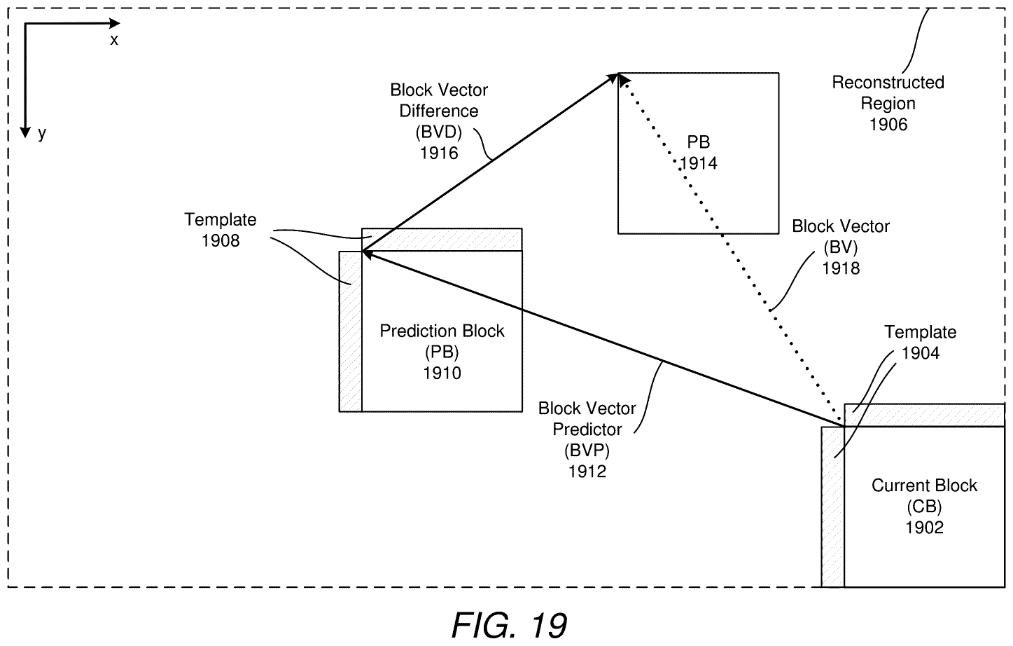

FIG. 19 illustrates an example of TMP for predicting a current block (CB) 1902, according to embodiments of the present disclosure. CB 1902 comprises a rectangular block of samples to be encoded by an encoder. The samples of CB 1902 are arranged in columns and rows.

To perform TMP for predicting CB 1902, an encoder may determine or construct a template 1904 of CB 1902. The encoder may determine or construct template 1904 based on samples in a reconstructed region 1906. Reconstructed region 1906 comprises reconstructed samples. A reconstructed sample is a sample that has been encoded and decoded. Reconstructed samples may differ from the corresponding original samples of a picture or frame because the encoding and decoding process may comprise a lossy process that loses information (e.g., a quantization process following transformation).

In an example, template 1904 may comprise samples in reconstructed region 1906 that are adjacent to the samples of CB 1902. For example, template 1904 may comprise samples in reconstructed region 1906 to the left and/or above current block 1902. In an example, template 1904 may comprise samples in reconstructed region 1906 from the column of samples directly adjacent to the left-most column of samples of CB 1902 and/or samples from the row of samples directly adjacent to the top-most row of samples of CB 1902. In another example, template 1904 may comprise samples in reconstructed region 1906 from a column of samples to the left of, but not directly adjacent to, the left-most column of samples of CB 1902 and/or reconstructed samples from the row of samples above, but not directly adjacent to, the top-most row of samples of CB 1902.

When template 1904 comprises samples in reconstructed region 1906 from both a column (or columns) of samples to the left of the left-most column of samples of current block 1902 and from a row (or rows) of samples above the top-most row of samples of current block 1902, template 1904 may have the shape of an L that is rotated clockwise by 90 degrees. In the example of FIG. 19, template 1904 has this rotated L-shape but does not include the sample(s) at the intersection of the top (or above) and left samples. In another example, template 1904 may comprise the sample(s) at the intersection of the top (or above) and left samples.

After determining or constructing template 1904, the encoder may search reconstructed region 1906 for a template of a prediction block (PB) that is determined to “best” match template 1904 of CB 1902. Reconstructed region 1906 comprises reconstructed samples of prior encoded and decoded samples of the current picture as described above. The encoder may search reconstructed region 1906 for a template of a PB that “best” matches template 1904 by determining a cost between template 1904 of CB 1902 and one or more templates of one or more PBs in reconstructed region 1906. The templates of the prediction blocks, e.g., template 1908 of PB 1910, may be of the same shape and size as template 1904 of CB 1902. In an example, the cost may be based on, for example, a difference (e.g., sum of squared differences (SSD), sum of absolute differences (SAD), sum of absolute transformed differences (SATD), or difference determined based on a hash function) between template 1908 of PB 1910 and template 1904 of CB 1902. In the example of FIG. 19, template 1908 of PB 1910 is determined to be the “best” match to template 1904 of CB 1902 (e.g., based on template 1908 having a smallest difference between template 1904 relative to the other templates in reconstructed region 1906).

After determining template 1908 of PB 1910 that “best” matches template 1904 of CB 1902, the encoder may determine a block vector predictor (BVP) 1912. For example, as illustrated by FIG. 19, BVP 1912 may indicate a displacement of PB 1910 relative to CB 1902. In an example, the encoder may determine BVP 1912 based on a difference between the location of CB 1902 and the location of PB 1910. In another example, the encoder may not determine BVP 1912 because the encoder determines the location of PB 1910 by TMP.

As described above, the encoder may determine that template 1908 of PB 1910 is the “best” match to template 1904 of CB 1902. However, for example, although template 1908 of PB 1910 may be highly correlated to template 1904 of CB 1902, PB 1910 itself may not be the “best” prediction of CB 1902.

Therefore, after determining BVP 1912, or after determining the location of PB 1910 by TMP, the encoder may determine that PB 1914 is a “better” match to CB 1902 by determining a cost between CB 1902 and one or more candidate prediction blocks (PBs) (e.g., including PB 1910) in reconstructed region 1906. In the example illustrated by FIG. 19, the encoder may determine a cost between CB 1902 and PB 1910 and a cost between CB 1902 and PB 1914. For example, the encoder may determine that PB 1914 is a “better” match to CB 1902 than PB 1910 because the cost between CB 1902 and PB 1914 is smaller than the cost between CB 1902 and PB 1910.

In an example, the cost may be based on one or more cost criterion, such as a rate-distortion criterion (e.g., Lagrangian rate-distortion cost). The one or more cost criterion may be based on, for example, a difference (e.g., a sample-by-sample difference, a sum of squared differences (SSD), sum of absolute differences (SAD), sum of absolute transformed differences (SATD), or difference determined based on a hash function) between CB 1902 and PB 1910, and between CB 1902 and PB 1914.

Next, the encoder may determine a block vector difference (BVD) 1916. For example, in FIG. 19, BVD 1916 may indicate the displacement of PB 1914 relative to the “best” matching PB or PB 1910 in the example of FIG. 19. In an example, the encoder may determine BVD 1916 based on a difference between the location of PB 1910 and the location of PB 1914 (e.g., a difference between horizontal positions of the two locations and a difference between vertical positions of the two locations). After determining BVD 1916, and/or after determining the location of PB 1914, the encoder may then use PB 1914 to predict CB 1902.

In further example embodiments, the encoder may determine a difference (e.g., a corresponding sample-by-sample difference) between CB 1902 and PB 1914. The difference may be referred to as a prediction error or residual. The encoder may then store and/or signal in a bitstream the prediction error or residual for decoding by the decoder.

Per the example illustration of FIG. 19, block vector (BV) 1918 may indicate the displacement between CB 1902 and PB 1914, further noting that, per above, the encoder may determine that PB 1914 is the “better” predictor of CB 1902 (compared to, e.g., PB 1910). However, with TMP, in order to reduce signaling overhead, the components of BV 1918 may not be signaled by the encoder to the decoder. Instead, the location of PB 1914 may be determined via the displacement of BVD 1916 from the previously determined location of PB 1910. In FIG. 19, BV 1918 is illustrated with a dotted line because it may not be determined or signaled in embodiments of the present disclosure.

To perform TMP for predicting CB 1902, a decoder may perform the same operations as the encoder as described above with respect to FIG. 19. For example, a decoder may determine or construct a template 1904 of CB 1902. After determining or constructing template 1904, the decoder may search reconstructed region 1906 for a template of a PB that is determined to “best” match template 1904 of CB 1902. For example, the decoder may determine that template 1908 of PB 1910 is the “best” match to template 1904 of CB 1902. After determining template 1908 that “best” matches template 1904, the decoder may determine a block vector predictor (BVP) 1912. For example, BVP 1912 may indicate a vector displacement between CB 1902 and PB 1910. In an example, the decoder may determine BVP 1912 based on a difference between the location of CB 1902 and the location of PB 1910. In another example, the decoder may not need to determine BVP 1912 because the decoder determines the location of PB 1910 by TMP.

In an example, the decoder may receive from the encoder, in a bitstream, an indication of BVD 1916. In another example, the decoder may determine a block vector (BV) 1918 based on BVP 1912 and BVD 1916. For example, in FIG. 19, BVD 1916 may indicate the displacement of PB 1914 relative to PB 1910, and BV 1918 may indicate the displacement of PB 1914 relative to CB 1902. In an example, the decoder may determine BV 1918 by adding BVP 1912 to BVD 1916. In an example, the decoder may determine the location of PB 1914 by displacing the location of CB 1902 by BV 1918. In another example, instead of determining BV 1918, the decoder may determine the location of PB 1914 by displacing the location of PB 1910 (determined using TMP) by BVD 1916. For example, the decoder may add the horizontal component of BVD 1916 to the horizontal location of PB 1910 and the vertical component of BVD 1916 to the vertical location of PB 1910 to respectively determine the horizontal and vertical location of PB 1914.

After determining the location of PB 1914, the decoder may then use PB 1914 to predict CB 1902. For example, the decoder may add the residual, received from the encoder, to PB 1914 to reconstruct CB 1902.

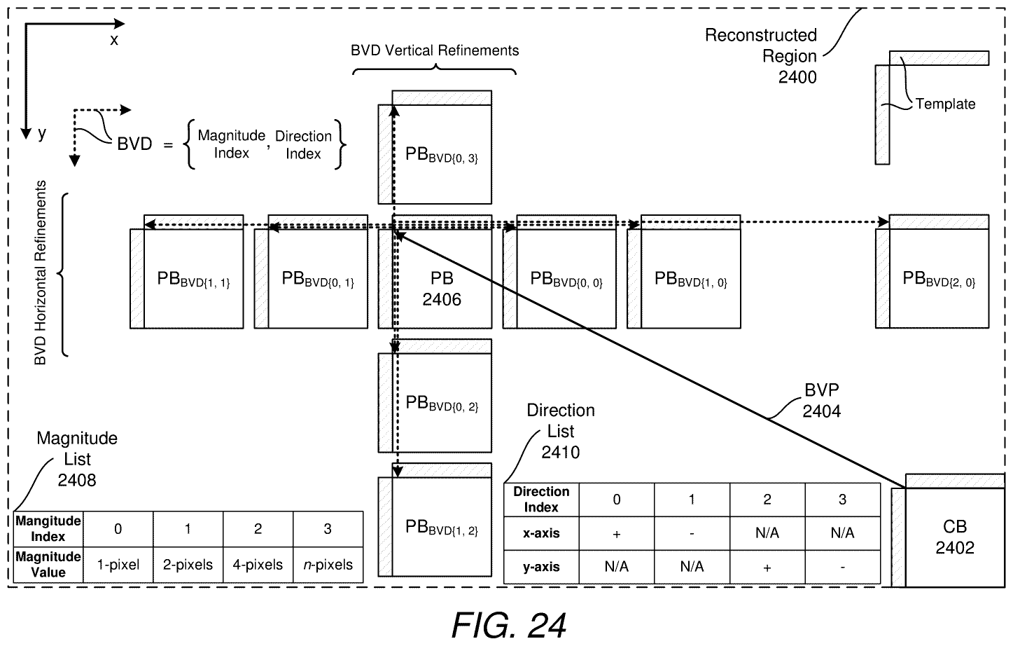

As discussed herein, determining a “better” or “best” matching PB displaced from a CB by a candidate BVD may also be referred to as “refining” or “improving” the prediction of a CB. Further details of how an encoder or decoder may determine one or more prediction blocks (PBs) and one or more respective candidate block vector differences (BVDs) are discussed below with respect to FIG. 24.

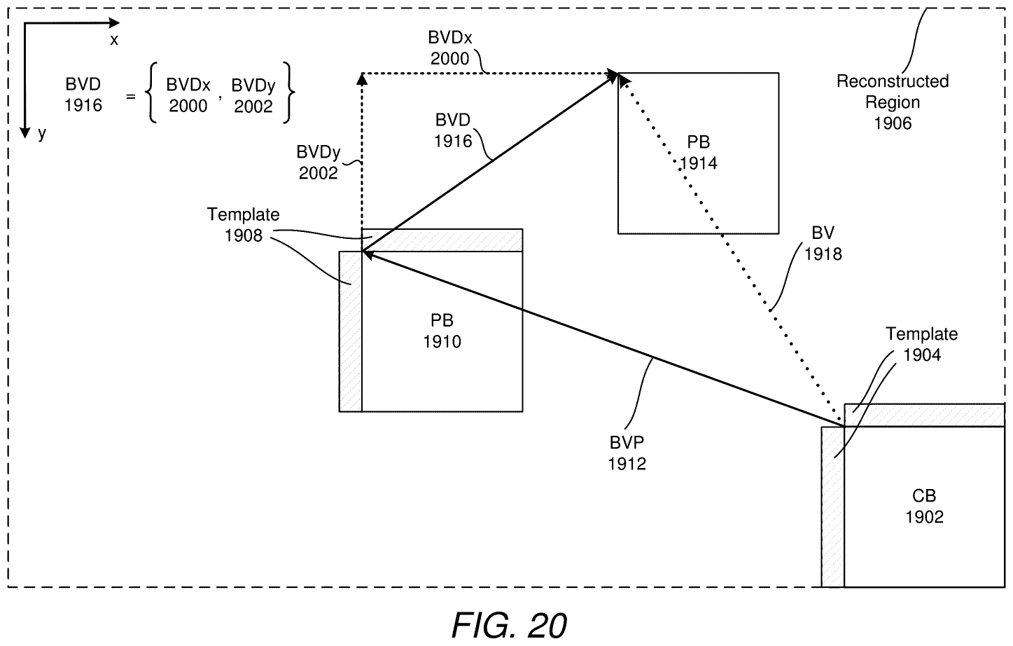

FIG. 20 illustrates an example representation of a BVD used in TMP in accordance with embodiments of the present disclosure.

In this example embodiment, TMP may be performed by the encoder and decoder in the same manner as described with regard to FIG. 19. FIG. 20 further illustrates a particular representation of the BVD, which may be used to provide an indication of the BVD by the encoder to the decoder.

In an example, to perform TMP for predicting CB 1902, an encoder may determine or construct a template 1904 of CB 1902. After determining or constructing template 1904, the encoder may search reconstructed region 1906 for a template of a prediction block (PB) that is determined to “best” match template 1904 of CB 1902. After determining template 1908 of PB 1910 that “best” matches template 1904 of CB 1902, the encoder may determine a block vector predictor (BVP) 1912. For example, BVP 1912 may indicate a displacement of PB 1910 relative to CB 1902. In an example, the encoder may determine BVP 1912 based on a difference between the location of CB 1902 and the location of PB 1910. In another example, the encoder may not determine BVP 1912 because the encoder determines the location of PB 1910 by TMP.

After determining BVP 1912, or after determining the location of PB 1910 by TMP, the encoder may determine that PB 1914 is a “better” match to CB 1902 by determining a cost between CB 1902 and one or more candidate prediction blocks (PBs) (e.g., including PB 1910) in reconstructed region 1906. For example, the encoder may determine that PB 1914 is a “better” match to CB 1902 than PB 1910 because the cost between CB 1902 and PB 1914 is smaller than the cost between CB 1902 and PB 1910.

Next, the encoder may determine a block vector difference (BVD) 1916. For example, BVD 1916 may indicate the displacement of PB 1914 relative to the “best” matching PB or PB 1910. In an example, the encoder may determine BVD 1916 based on a difference between the location of PB 1910 and the location of PB 1914 (e.g., a difference between horizontal positions of the two locations and a difference between vertical positions of the two locations). After determining BVD 1916, and/or after determining the location of PB 1914, the encoder may then use PB 1914 to predict CB 1902.

In further example embodiments, the encoder may determine a difference (e.g., a corresponding sample-by-sample difference) between CB 1902 and PB 1914. The difference may be referred to as a prediction error or residual. The encoder may then store and/or signal in a bitstream the prediction error or residual for decoding by the decoder.

In an example illustrated by FIG. 20, block vector (BV) 1918 may indicate the displacement between CB 1902 and PB 1914, further noting that, per above, the encoder may determine that PB 1914 is the “better” predictor of CB 1902 (compared to, e.g., PB 1910). However, with TMP, in order to reduce signaling overhead, the components of BV 1918 may not be signaled by the encoder to the decoder. Instead, the location of PB 1914 may be determined via the displacement of BVD 1916 from the previously determined location of PB 1910. In FIG. 20, BV 1918 is illustrated with a dotted line because it may not be determined or signaled in embodiments of the present disclosure.

To perform TMP for predicting CB 1902, a decoder may perform the same operations as the encoder as described above. For example, a decoder may determine or construct a template 1904 of CB 1902. After determining or constructing template 1904, the decoder may search reconstructed region 1906 for a template of a PB that is determined to “best” match template 1904 of CB 1902. For example, the decoder may determine that template 1908 of PB 1910 is the “best” match to template 1904 of CB 1902. After determining template 1908 that “best” matches template 1904, the decoder may determine a block vector predictor (BVP) 1912. For example, BVP 1912 may indicate a vector displacement between CB 1902 and PB 1910. In an example, the decoder may determine BVP 1912 based on a difference between the location of CB 1902 and the location of PB 1910. In another example, the decoder may not need to determine BVP 1912 because the decoder determines the location of PB 1910 by TMP.

In an example, the decoder may receive from the encoder, in a bitstream, an indication of BVD 1916. In an example illustrated by FIG. 20, BVD 1916 may be represented by a horizontal component and a vertical component. More specifically, BVD 1916 comprises BVD horizontal component (BVDₓ) 2000 and BVD vertical component (BVD_{y}) 2002. In some embodiments, an encoder may signal, in a bitstream, a representation of BVD 1916 as the combination of BVD horizontal component 2000 and BVD vertical component 2002. Similarly, in some embodiments, a decoder may receive, in a bitstream, a representation of BVD 1916 as the combination of BVD horizontal component 2000 and BVD vertical component 2002.

An advantage of this particular representation of a BVD is that it may represent any vector magnitude and any vector direction, which enhances flexibility. A disadvantage of this particular representation of a BVD is that the data size (e.g., signaling overhead) may be comparatively larger than other representations of a BVD, which are described in more detail below.

In another example, the decoder may determine a block vector (BV) 1918 based on BVP 1912 and BVD 1916. For example, in FIG. 20, BVD 1916 may indicate the displacement of PB 1914 relative to PB 1910, and BV 1918 may indicate the displacement of PB 1914 relative to CB 1902. In an example, the decoder may determine BV 1918 by adding BVP 1912 to BVD 1916. In an example, the decoder may determine the location of PB 1914 by displacing the location of CB 1902 by BV 1918. In another example, instead of determining BV 1918, the decoder may determine the location of PB 1914 by displacing the location of PB 1910 (determined using TMP) by BVD 1916. For example, the decoder may add the horizontal component of BVD 1916 to the horizontal location of PB 1910 and the vertical component of BVD 1916 to the vertical location of PB 1910 to respectively determine the horizontal and vertical location of PB 1914.

After determining the location of PB 1914, the decoder may then use PB 1914 to predict CB 1902. For example, the decoder may add the residual, received from the encoder, to PB 1914 to reconstruct CB 1902.

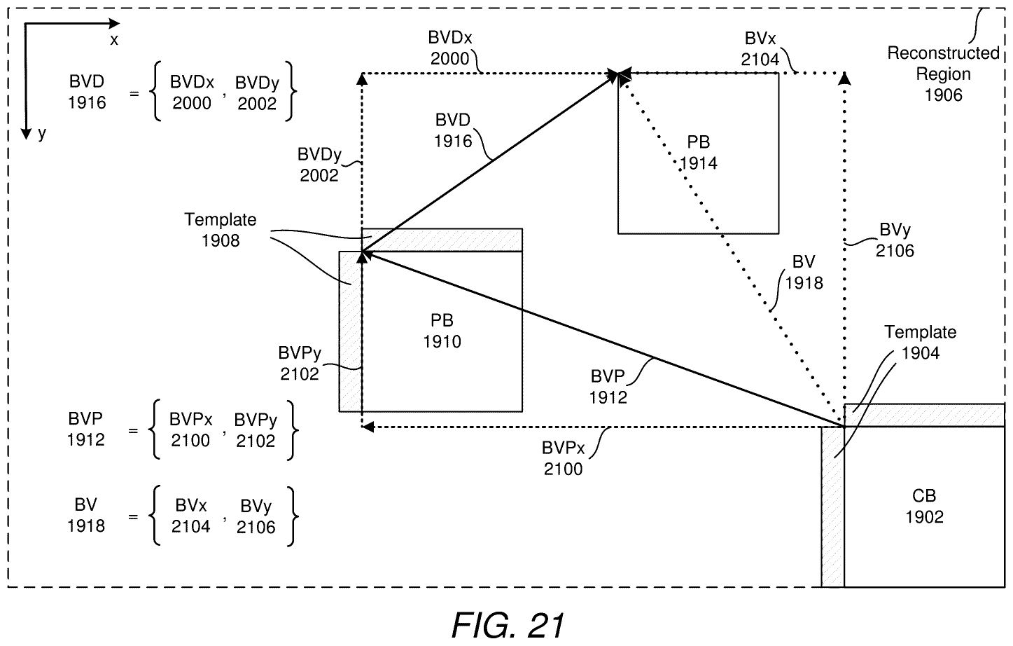

FIG. 21 illustrates an example representation of a BVP, a BVD, and a BV used in TMP in accordance with embodiments of the present disclosure.

In this example embodiment, TMP may be performed by the encoder and decoder in the same manner as described with regard to FIG. 19. FIG. 21 further illustrates an example of determining the BV based on the BVP and the BVD.

In an example, to perform TMP for predicting CB 1902, an encoder may determine or construct a template 1904 of CB 1902. After determining or constructing template 1904, the encoder may search reconstructed region 1906 for a template of a prediction block (PB) that is determined to “best” match template 1904 of CB 1902. After determining template 1908 of PB 1910 that “best” matches template 1904 of CB 1902, the encoder may determine a block vector predictor (BVP) 1912. For example, BVP 1912 may indicate a displacement of PB 1910 relative to CB 1902. In an example, the encoder may determine BVP 1912 based on a difference between the location of CB 1902 and the location of PB 1910. In another example, the encoder may not determine BVP 1912 because the encoder determines the location of PB 1910 by TMP.

After determining BVP 1912, or after determining the location of PB 1910 by TMP, the encoder may determine that PB 1914 is a “better” match to CB 1902 by determining a cost between CB 1902 and one or more candidate prediction blocks (PBs) (e.g., including PB 1910) in reconstructed region 1906. For example, the encoder may determine that PB 1914 is a “better” match to CB 1902 than PB 1910 because the cost between CB 1902 and PB 1914 is smaller than the cost between CB 1902 and PB 1910.

Next, the encoder may determine a block vector difference (BVD) 1916. For example, BVD 1916 may indicate the displacement of PB 1914 relative to the “best” matching PB or PB 1910. In an example, the encoder may determine BVD 1916 based on a difference between the location of PB 1910 and the location of PB 1914 (e.g., a difference between horizontal positions of the two locations and a difference between vertical positions of the two locations). After determining BVD 1916, and/or after determining the location of PB 1914, the encoder may then use PB 1914 to predict CB 1902.

In further example embodiments, the encoder may determine a difference (e.g., a corresponding sample-by-sample difference) between CB 1902 and PB 1914. The difference may be referred to as a prediction error or residual. The encoder may then store and/or signal in a bitstream the prediction error or residual for decoding by the decoder.

In an example illustrated by FIG. 21, block vector (BV) 1918 may indicate the displacement between CB 1902 and PB 1914, further noting that, per above, the encoder may determine that PB 1914 is the “better” predictor of CB 1902 (compared to, e.g., PB 1910). However, with TMP, in order to reduce signaling overhead, the components of BV 1918 may not be signaled by the encoder to the decoder. Instead, the location of PB 1914 may be determined via the displacement of BVD 1916 from the previously determined location of PB 1910. In FIG. 21, BV 1918 is illustrated with a dotted line because it may not be determined or signaled in embodiments of the present disclosure.

To perform TMP for predicting CB 1902, a decoder may perform the same operations as the encoder as described above. For example, a decoder may determine or construct a template 1904 of CB 1902. After determining or constructing template 1904, the decoder may search reconstructed region 1906 for a template of a PB that is determined to “best” match template 1904 of CB 1902. For example, the decoder may determine that template 1908 of PB 1910 is the “best” match to template 1904 of CB 1902. After determining template 1908 that “best” matches template 1904, the decoder may determine a block vector predictor (BVP) 1912. For example, BVP 1912 may indicate a vector displacement between CB 1902 and PB 1910. In an example, the decoder may determine BVP 1912 based on a difference between the location of CB 1902 and the location of PB 1910. In another example, the decoder may not need to determine BVP 1912 because the decoder determines the location of PB 1910 by TMP.

In an example, the decoder may receive from the encoder, in a bitstream, an indication of BVD 1916. In another example, the decoder may determine a block vector (BV) 1918 based on BVP 1912 and BVD 1916. For example, in FIG. 21, BVD 1916 may indicate the displacement of PB 1914 relative to PB 1910, and BV 1918 may indicate the displacement of PB 1914 relative to CB 1902. In an example, the decoder may determine BV 1918 by adding BVP 1912 to BVD 1916. In an example illustrated by FIG. 21, the decoder may determine a block vector (BV) 1918 by performing component-vector addition of BVP 1912 and BVD 1916. For example, the decoder may determine BV horizontal component (BVₓ) 2104 by adding BVP horizontal component (BVPₓ) 2100 to BVD horizontal component (BVDₓ) 2000. Similarly, the decoder may determine BV vertical component (BV_{y}) 2106 by adding BVP vertical component (BVP_{y}) 2102 to BVD vertical component (BVD_{y}) 2002. In an example, the decoder may determine the location of PB 1914 by displacing the location of CB 1902 by BV 1918.

In another example, instead of determining BV 1918, the decoder may determine the location of PB 1914 by displacing the location of PB 1910 (determined using TMP) by BVD 1916. For example, the decoder may add the horizontal component of BVD 1916 to the horizontal location of PB 1910 and the vertical component of BVD 1916 to the vertical location of PB 1910 to respectively determine the horizontal and vertical location of PB 1914.

After determining the location of PB 1914, the decoder may then use PB 1914 to predict CB 1902. For example, the decoder may add the residual, received from the encoder, to PB 1914 to reconstruct CB 1902.

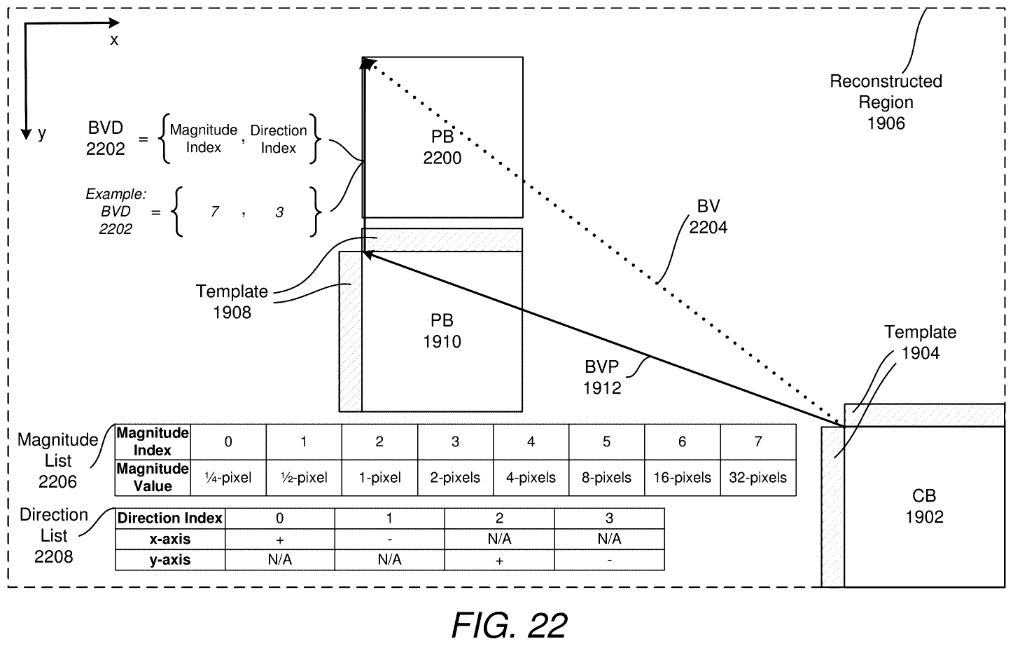

FIG. 22 illustrates an example representation of a BVD used in TMP in accordance with embodiments of the present disclosure.

In this example embodiment, TMP may be performed by the decoder and encoder in the same manner as described with regard to FIG. 19. FIG. 22 further illustrates a particular representation of the BVD, which may be used to provide an indication of the BVD by the encoder to the decoder.

In an example, to perform TMP for predicting CB 1902, an encoder may determine or construct a template 1904 of CB 1902. After determining or constructing template 1904, the encoder may search reconstructed region 1906 for a template of a prediction block (PB) that is determined to “best” match template 1904 of CB 1902. After determining template 1908 of PB 1910 that “best” matches template 1904 of CB 1902, the encoder may determine a block vector predictor (BVP) 1912. For example, BVP 1912 may indicate a displacement of PB 1910 relative to CB 1902. In an example, the encoder may determine BVP 1912 based on a difference between the location of CB 1902 and the location of PB 1910. In another example, the encoder may not determine BVP 1912 because the encoder determines the location of PB 1910 by TMP.

After determining BVP 1912, or after determining the location of PB 1910 by TMP, the encoder may determine that PB 2200 is a “better” match to CB 1902 by determining a cost between CB 1902 and one or more candidate prediction blocks (PBs) (e.g., including PB 1910) in reconstructed region 1906. For example, the encoder may determine that PB 2200 is a “better” match to CB 1902 than PB 1910 because the cost between CB 1902 and PB 2200 is smaller than the cost between CB 1902 and PB 1910.

Next, the encoder may determine a block vector difference (BVD) 2202. For example, in FIG. 22, BVD 2202 may indicate the displacement of PB 2200 relative to the “best” matching PB or PB 1910. In an example, the encoder may determine BVD 2202 based on a difference between the location of PB 1910 and the location of PB 2200 (e.g., a difference between horizontal positions of the two locations and a difference between vertical positions of the two locations). After determining BVD 2202, and/or after determining the location of PB 2200, the encoder may then use PB 2200 to predict CB 1902.

In further example embodiments, the encoder may determine a difference (e.g., a corresponding sample-by-sample difference) between CB 1902 and PB 2200. The difference may be referred to as a prediction error or residual. The encoder may then store and/or signal in a bitstream the prediction error or residual for decoding by the decoder.

In an example illustrated by FIG. 22, block vector (BV) 2204 may indicate the displacement between CB 1902 and PB 2200, further noting that, per above, the encoder may determine that PB 2200 is the “better” predictor of CB 1902 (compared to, e.g., PB 1910). However, with TMP, in order to reduce signaling overhead, the components of BV 2204 may not be signaled by the encoder to the decoder. Instead, the location of PB 2200 may be determined via the displacement of BVD 2202 from the previously determined location of PB 1910. In FIG. 22, BV 2204 is illustrated with a dotted line because it may not be determined or signaled in embodiments of the present disclosure.

To perform TMP for predicting CB 1902, a decoder may perform the same operations as the encoder as described above. For example, a decoder may determine or construct a template 1904 of CB 1902. After determining or constructing template 1904, the decoder may search reconstructed region 1906 for a template of a PB that is determined to “best” match template 1904 of CB 1902. For example, the decoder may determine that template 1908 of PB 1910 is the “best” match to template 1904 of CB 1902. After determining template 1908 that “best” matches template 1904, the decoder may determine a block vector predictor (BVP) 1912. For example, BVP 1912 may indicate a vector displacement between CB 1902 and PB 1910. In an example, the decoder may determine BVP 1912 based on a difference between the location of CB 1902 and the location of PB 1910. In another example, the decoder may not need to determine BVP 1912 because the decoder determines the location of PB 1910 by TMP.

In an example, the decoder may receive from the encoder, in a bitstream, an indication of BVD 2202. In another example, the decoder may determine a block vector (BV) 2204 based on BVP 1912 and BVD 2202. For example, in FIG. 22, BVD 2202 may indicate the displacement of PB 2200 relative to PB 1910, and BV 2204 may indicate the displacement of PB 2200 relative to CB 1902. In an example, the decoder may determine BV 2204 by adding BVP 1912 to BVD 2202. In an example, the decoder may determine the location of PB 2200 by displacing the location of CB 1902 by BV 2204. In another example, instead of determining BV 2204, the decoder may determine the location of PB 2200 by displacing the location of PB 1910 (determined using TMP) by BVD 2202. For example, the decoder may add the horizontal component of BVD 2202 to the horizontal location of PB 1910 and the vertical component of BVD 2202 to the vertical location of PB 1910 to respectively determine the horizontal and vertical location of PB 2200.

After determining the location of PB 2200, the decoder may then use PB 2200 to predict CB 1902. For example, the decoder may add the residual, received from the encoder, to PB 2200 to reconstruct CB 1902.

In an example illustrated by FIG. 22, BVD 2202 may be represented by a magnitude and a direction. The magnitude may be selected from a pre-defined list. As illustrated, magnitude list 2206 comprises a list of magnitude values comprising: ¼, ½, 1, 2, 4, 8, 16, and 32. The magnitude values of magnitude list 2206 may be represented in units of pixels. Each magnitude value of magnitude list 2206 may be referenced by a magnitude index. As illustrated, the magnitude indices range from 0 to 7. In practice, the magnitude indices may be represented by an encoding, such as a binary encoding, in order to reduce the overhead of representation.

In embodiments, the magnitude values may comprise: 1, 2, 4, 8, 16, 32, 48, 64, 80, 96, 112, and 128. In further embodiments, the magnitude values may comprise: 1, 2, 4, 8, 12, 16, 24, 32, 40, 48, 56, 64, 72, 80, 88, 96, 104, 112, 120, and 128.

Further, the direction may be selected from a pre-defined list. As illustrated, direction list 2208 comprises a list of directions comprising: a positive, horizontal direction (x-axis +); a negative, horizontal direction (x-axis −); a positive, vertical direction (y-axis +); and a negative, vertical direction (y-axis −). Each direction of direction list 2208 may be referenced by a direction index. As illustrated, the direction indices range from 0 to 3. In practice, the magnitude indices may be represented by an encoding, such as a binary encoding, in order to reduce the overhead of representation.

In further embodiments, the directions may comprise one or more of: a positive, horizontal direction; a negative, horizontal direction; a positive, vertical direction; and a negative, vertical direction. This may allow for enhanced flexibility regarding the representation of the direction of BVD 2202. It should be noted that the directions in direction list 2208 are illustrated by example and not by limitation. For example, in certain embodiments, other directions may include diagonal directions to enhance flexibility regarding the representation of the direction(s) of BVD 2202.

The magnitude and direction of BVD 2202 may be determined using an index to the magnitude list, and an index to the direction list, in order to reduce the signaling cost for the BVD. As illustrated, the example BVD 2202 may be represented by: {magnitude index 7 (32-pixels), direction index 3 (y-axis −)}.

For ease of illustration in FIG. 22, the magnitude of displacement of PB 2200 from PB 1910, by BVD 2202, does not exactly match the example value (of 32-pixels) as depicted. Further, in practice, the reconstructed region 1906, CB 1902, PB 1910, and PB 2200 may each be of varying sizes for reasons described above.

In some embodiments, an encoder may signal, in a bitstream, a representation of BVD 2202 as the combination of the index to the magnitude, in magnitude list 2206, and the index to the direction, in direction list 2208. Similarly, in some embodiments, a decoder may receive, in a bitstream, a representation of BVD 2202 as the combination of the index to the magnitude, in magnitude list 2206, and the index to the direction, in direction list 2208.

An advantage of this particular representation of a BVD is that it may allow for signaling a BVD with reduced overhead. Further, another advantage of this particular representation of a BVD is that it may represent a BVD with more than one direction in order to enhance flexibility while still reducing signaling overhead.

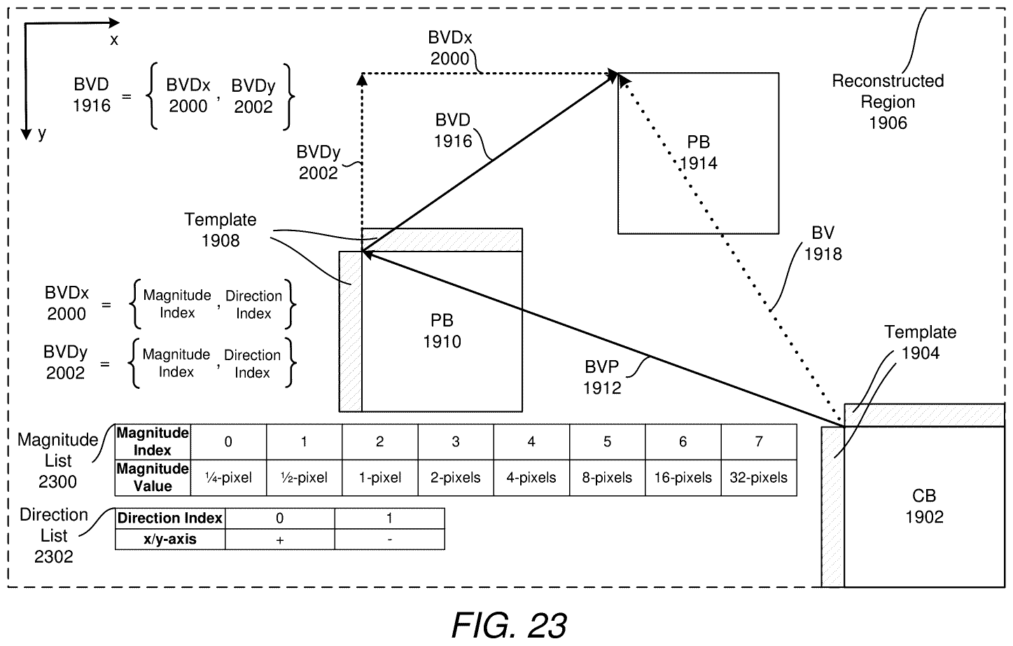

FIG. 23 illustrates an example representation of a BVD used in TMP in accordance with embodiments of the present disclosure.

In this example embodiment, TMP may be performed by the encoder and decoder in the same manner as described with regard to FIG. 19. FIG. 23 further illustrates another particular representation of the BVD, which may be used to provide an indication of the BVD by the encoder to the decoder. In an example illustrated by FIG. 23, BVD 1916 may be represented by BVD horizontal component (BVDₓ) 2000 and BVD vertical component (BVD_{y}) 2002, and each of BVDₓ 2000 and BVD_{y} 2002 may be represented by a magnitude and a direction.

In an example, to perform TMP for predicting CB 1902, an encoder may determine or construct a template 1904 of CB 1902. After determining or constructing template 1904, the encoder may search reconstructed region 1906 for a template of a prediction block (PB) that is determined to “best” match template 1904 of CB 1902. After determining template 1908 of PB 1910 that “best” matches template 1904 of CB 1902, the encoder may determine a block vector predictor (BVP) 1912. For example, BVP 1912 may indicate a displacement of PB 1910 relative to CB 1902. In an example, the encoder may determine BVP 1912 based on a difference between the location of CB 1902 and the location of PB 1910. In another example, the encoder may not determine BVP 1912 because the encoder determines the location of PB 1910 by TMP.

After determining BVP 1912, or after determining the location of PB 1910 by TMP, the encoder may determine that PB 1914 is a “better” match to CB 1902 by determining a cost between CB 1902 and one or more candidate prediction blocks (PBs) (e.g., including PB 1910) in reconstructed region 1906. For example, the encoder may determine that PB 1914 is a “better” match to CB 1902 than PB 1910 because the cost between CB 1902 and PB 1914 is smaller than the cost between CB 1902 and PB 1910.

Next, the encoder may determine a block vector difference (BVD) 1916. For example, BVD 1916 may indicate the displacement of PB 1914 relative to the “best” matching PB or PB 1910. In an example, the encoder may determine BVD 1916 based on a difference between the location of PB 1910 and the location of PB 1914 (e.g., a difference between horizontal positions of the two locations and a difference between vertical positions of the two locations). After determining BVD 1916, and/or after determining the location of PB 1914, the encoder may then use PB 1914 to predict CB 1902.

In further example embodiments, the encoder may determine a difference (e.g., a corresponding sample-by-sample difference) between CB 1902 and PB 1914. The difference may be referred to as a prediction error or residual. The encoder may then store and/or signal in a bitstream the prediction error or residual for decoding by the decoder.

In an example illustrated by FIG. 23, block vector (BV) 1918 may indicate the displacement between CB 1902 and PB 1914, further noting that, per above, the encoder may determine that PB 1914 is the “better” predictor of CB 1902 (compared to, e.g., PB 1910). However, with TMP, in order to reduce signaling overhead, the components of BV 1918 may not be signaled by the encoder to the decoder. Instead, the location of PB 1914 may be determined via the displacement of BVD 1916 from the previously determined location of PB 1910. In FIG. 23, BV 1918 is illustrated with a dotted line because it may not be determined or signaled in embodiments of the present disclosure.

To perform TMP for predicting CB 1902, a decoder may perform the same operations as the encoder as described above. For example, a decoder may determine or construct a template 1904 of CB 1902. After determining or constructing template 1904, the decoder may search reconstructed region 1906 for a template of a PB that is determined to “best” match template 1904 of CB 1902. For example, the decoder may determine that template 1908 of PB 1910 is the “best” match to template 1904 of CB 1902. After determining template 1908 that “best” matches template 1904, the decoder may determine a block vector predictor (BVP) 1912. For example, BVP 1912 may indicate a vector displacement between CB 1902 and PB 1910. In an example, the decoder may determine BVP 1912 based on a difference between the location of CB 1902 and the location of PB 1910. In another example, the decoder may not need to determine BVP 1912 because the decoder determines the location of PB 1910 by TMP.

In an example, the decoder may receive from the encoder, in a bitstream, an indication of BVD 1916. In another example, the decoder may determine a block vector (BV) 1918 based on BVP 1912 and BVD 1916. For example, in FIG. 20, BVD 1916 may indicate the displacement of PB 1914 relative to PB 1910, and BV 1918 may indicate the displacement of PB 1914 relative to CB 1902. In an example, the decoder may determine BV 1918 by adding BVP 1912 to BVD 1916. In an example, the decoder may determine the location of PB 1914 by displacing the location of CB 1902 by BV 1918. In another example, instead of determining BV 1918, the decoder may determine the location of PB 1914 by displacing the location of PB 1910 (determined using TMP) by BVD 1916. For example, the decoder may add the horizontal component of BVD 1916 to the horizontal location of PB 1910 and the vertical component of BVD 1916 to the vertical location of PB 1910 to respectively determine the horizontal and vertical location of PB 1914.

After determining the location of PB 1914, the decoder may then use PB 1914 to predict CB 1902. For example, the decoder may add the residual, received from the encoder, to PB 1914 to reconstruct CB 1902.

In an example illustrated by FIG. 23, BVD 1916 may be represented by BVD horizontal component (BVDₓ) 2000 and BVD vertical component (BVD_{y}) 2002, and each of BVDₓ 2000 and BVD_{y} 2002 may be represented by a magnitude and a direction.

More specifically, the magnitude of BVDₓ 2000 may be represented by an index to magnitude list 2300, and the direction of BVDₓ 2000 may be represented by an index to direction list 2302. As illustrated in FIG. 23, the example of BVDₓ 2000 may be represented by: {magnitude index 7 (32-pixels), direction index 0 (x-axis +)}.

Similarly, the magnitude of BVD_{y} 2002 may be represented by an index to magnitude list 2300, and the direction of BVD_{y} 2002 may be represented by an index to direction list 2302. As illustrated in FIG. 23, the example of BVD_{y} 2002 may be represented by: {magnitude index 6 (16-pixels), direction index 1 (y-axis −)}.

For ease of illustration in FIG. 23, the magnitude of displacement of PB 1914 from PB 1910, by BVD 1916 represented by BVDₓ 2000 and BVD_{y} 2002, does not exactly match the example values as depicted. Further, in practice, the reconstructed region 1906, CB 1902, PB 1910, and PB 1914 may each be of varying sizes for reasons described above.

The magnitude may be selected from a pre-defined list. As illustrated, magnitude list 2300 comprises a list of magnitude values comprising: ¼, ½, 1, 2, 4, 8, 16, and 32. The magnitude values of magnitude list 2300 may be represented in units of pixels. Each magnitude value of magnitude list 2300 may be referenced by a magnitude index. As illustrated, the magnitude indices range from 0 to 7. In practice, the magnitude indices may be represented by an encoding, such as a binary encoding, in order to reduce the overhead of representation.

Further, the direction may be selected from a pre-defined list. As illustrated, direction list 2302 comprises a list of directions comprising: a positive direction (x/y-axis +); and a negative direction (x/y-axis −). Each direction of direction list 2302 may be referenced by a direction index. As illustrated, the direction indices range from 0 to 1. In practice, the magnitude indices may be represented by an encoding, such as a binary encoding, in order to reduce the overhead of representation.

In some embodiments, an encoder may signal, in a bitstream, a representation of BVD 1916 as the combination of BVDₓ 2000 and BVD_{y} 2002, as described above. Similarly, in some embodiments, a decoder may receive, in a bitstream, a representation of BVD 1916 as the combination of BVDₓ 2000 and BVD_{y} 2002, as described above.

An advantage of this mode is that a BVD may be represented by a magnitude and a direction for each of a horizontal component and a vertical component of the BVD, in order to enhance flexibility while still reducing signaling overhead.

FIG. 24 illustrates an example of TMP combined with BVD refinement in accordance with embodiments of the present disclosure.

In this example embodiment, TMP may be performed by the decoder and encoder in the same manner as described with regard to FIG. 19. FIG. 24 further illustrates TMP combined with an additional procedure termed herein as BVD refinement.

In the example illustrated by FIG. 24, reconstructed region 2400 is essentially the same as reference reconstructed region 1906 but is renumbered for ease of illustration. In an example, to perform TMP for predicting CB 2402, an encoder may determine or construct a template of CB 2402. After determining or constructing the template of CB 2402, the encoder may search reconstructed region 2400 for a template of a prediction block (PB) that is determined to “best” match the template of CB 2402. After determining a template of PB 2406 that “best” matches the template of CB 2402, the encoder may determine a block vector predictor (BVP) 2404. For example, BVP 2404 may indicate a displacement of PB 2406 relative to CB 2402. In an example, the encoder may determine BVP 2404 based on a difference between the location of CB 2402 and the location of PB 2406. In another example, the encoder may not determine BVP 2404 because the encoder determines the location of PB 2406 by TMP.

In an example, after determining BVP 2404, or after determining the location of PB 2406 by TMP, the encoder may determine that a second PB is a “better” match to CB 2402 by determining a cost between CB 2402 and one or more candidate prediction blocks (PBs) (e.g., including PB 2406) in reconstructed region 2400. For example, the encoder may determine that a second PB is a “better” match to CB 2402 than PB 2406 because the cost between CB 2402 and the second PB is smaller than the cost between CB 2402 and PB 2406.

Next, the encoder may determine a block vector difference (BVD). For example, the BVD may indicate the displacement of the second PB relative to the “best” matching PB or PB 2406. In an example, the encoder may determine the BVD based on a difference between the location of PB 2406 and the location of the second PB (e.g., a difference between horizontal positions of the two locations and a difference between vertical positions of the two locations). After determining the BVD, and/or after determining the location of the second PB, the encoder may then use the second PB to predict CB 2402.

In further example embodiments, the encoder may determine a difference (e.g., a corresponding sample-by-sample difference) between CB 2402 and the second PB. The difference may be referred to as a prediction error or residual. The encoder may then store and/or signal in a bitstream the prediction error or residual for decoding by the decoder.

To perform TMP for predicting CB 2402, a decoder may perform the same operations as the encoder as described above. For example, a decoder may determine or construct a template of CB 2402. After determining or constructing the template of CB 2402, the decoder may search reconstructed region 2400 for a template of a PB that is determined to “best” match the template of CB 2402. For example, the decoder may determine that a template of PB 2406 is the “best” match to the template of CB 2402. After determining the template of PB 2406 that “best” matches the template of CB 2402, the decoder may determine a block vector predictor (BVP) 2404. For example, BVP 2404 may indicate a vector displacement between CB 2402 and PB 2406. In an example, the decoder may determine BVP 2404 based on a difference between the location of CB 2402 and the location of PB 2406. In another example, the decoder may not need to determine BVP 2404 because the decoder determines the location of PB 2406 by TMP.

In an example, the decoder may receive from the encoder, in a bitstream, an indication of a BVD. In another example, the decoder may determine a block vector (BV) based on BVP 2404 and the BVD. For example, the BVD may indicate the displacement of the second PB relative to PB 2406, and the BV may indicate the displacement of the second PB relative to CB 2402. In an example, the decoder may determine the BV by adding BVP 2404 to the BVD. In an example, the decoder may determine the location of the second PB by displacing the location of CB 2402 by the BV. In another example, instead of determining the BV, the decoder may determine the location of the second PB by displacing the location of PB 2406 (determined using TMP) by the BVD. For example, the decoder may add the horizontal component of the BVD to the horizontal location of PB 2406 and the vertical component of the BVD to the vertical location of PB 2406 to respectively determine the horizontal and vertical location of the second PB.

After determining the location of the second PB, the decoder may then use the second PB to predict CB 2402. For example, the decoder may add the residual, received from the encoder, to the second PB to reconstruct CB 2402.

In BVD refinement, on the decoder side, the step of determining the BV based on the BVP and the BVD may be expanded to include evaluating multiple candidate BVDs. In certain embodiments, for each respective candidate BVD of a plurality of candidate BVDs, the decoder may determine a cost of a template of a PB displaced from the first PB by the respective candidate BVD. Then, the decoder may select one or more of the plurality of candidate BVDs, based on the costs, for decoding the CB.

In further decoder-side embodiments, the one or more of the plurality of candidate BVDs may correspond to a number of the plurality of the candidate BVDs with the smallest costs among the costs. In embodiments, the number may be the 12 candidate BVDs with the smallest costs among the costs. In further decoder-side embodiments, the determining the cost of the template of the PB displaced from the first PB by the respective candidate BVD further comprises determining a difference between the template of the PB displaced from the first PB by the respective candidate BVD and the template of the CB. In embodiments, the difference may be a Sum of Absolute Differences (SAD). In further decoder-side embodiments, the decoder may receive, in a bitstream, an indication of a selected candidate BVD among the plurality of candidate BVDs, wherein the selected candidate BVD is the BVD.

In BVD refinement, on the encoder side, the step of determining a cost of the candidate BVD based on a PB displaced from the first PB by the respective candidate BVD may be expanded to include evaluating multiple candidate BVDs. In certain embodiments, for each respective candidate BVD of a plurality of candidate BVDs, the encoder may determine a cost of the candidate BVD based on a PB displaced from the first PB by the respective candidate BVD. Then, the encoder may signal, in a bitstream, an indication of a selected candidate BVD from the one or more of the plurality of the candidate BVDs, based on the costs.

In further encoder-side embodiments, the one or more of the plurality of candidate BVDs may correspond to a number of the plurality of the candidate BVDs with the smallest costs among the costs. For example, the number may be the 12 candidate BVDs with the smallest costs among the costs. In further encoder-side embodiments, for each respective candidate BVD of the plurality of candidate BVDs, the encoder may determine a cost of a template of the PB displaced from the first PB by the respective candidate BVD. Then, the encoder may select the one or more of the plurality of candidate BVDs based on the costs.

In further encoder-side embodiments, the determining the cost of the template of the PB displaced from the first PB by the respective candidate BVD further comprises determining a difference between the template of the PB displaced from the first PB by the respective candidate BVD and the template of the CB. In embodiments, the difference may be a Sum of Absolute Differences (SAD).

In further encoder-side embodiments, the encoder may signal, in a bitstream, an indication of a selected candidate BVD among the plurality of candidate BVDs, wherein the selected candidate BVD is the BVD.

Now referring again to FIG. 24, BVD refinement is illustrated using a simplified subset of candidate BVDs for ease of illustration. TMP may be performed for CB 2402 and its template, and for PB 2406 and its template, as indicated by BVP 2404.

As illustrated, a set of candidate BVDs may be determined, in reconstructed region 2400, based on a set of BVD refinement positions, the refinement positions comprising both BVD horizontal refinements and BVD vertical refinements.

More specifically, starting from PB 2406, each candidate BVD may represent a magnitude and direction of displacement from PB 2406 to a corresponding PB. The set of candidate BVDs may thus indicate a set of PBs displaced from PB 2406 by each candidate BVD. Each candidate BVD may be represented by a magnitude index and a direction index. As illustrated, each PB is designated by the identifier of its corresponding candidate BVD (i.e., {magnitude index, direction index}), for example:
In the horizontal, positive direction, PB_{BVD{0, 0}}, PB_{BVD{1, 0}}, PB_{BVD{2, 0}};
In the horizontal, negative direction, PB_{BVD{0, 1}}, PB_{BVD{1, 1}};
In the vertical, positive direction: PB_{BVD{0, 2}}, PB_{BVD{1, 2}}; and
In the vertical, negative direction: PB_{BVD{0, 3}}
   where the set of PBs displaced by each candidate BVD form the set of BVD refinement positions, as illustrated by FIG. 24.

The magnitudes may be selected from magnitude list 2408. As illustrated, magnitude list 2408 comprises a list of magnitude values comprising: 1-pixel, 2-pixels, 4-pixels, and n-pixels (an arbitrary amount). Each magnitude value of magnitude list 2408 may be referenced by a magnitude index. As illustrated, the magnitude indices range from 0 to 3. In practice, the magnitude indices may be represented by an encoding, such as a binary encoding, in order to reduce the overhead of representation.

Similarly, the directions may be selected from direction list 2410. As illustrated, direction list 2410 comprises a list of directions comprising: a positive, horizontal direction (x-axis +); a negative, horizontal direction (x-axis −); a positive, vertical direction (y-axis +); and a negative, vertical direction (y-axis −). Each direction of direction list 2410 may be referenced by a direction index. As illustrated, the direction indices range from 0 to 3. In practice, the magnitude indices may be represented by an encoding, such as a binary encoding, in order to reduce the overhead of representation.

For ease of illustration in FIG. 24, the magnitudes of displacement of the PBs from PB 2406, by the candidate BVDs, do not exactly match the example values as depicted. Further, in practice, the reconstructed region 2400, CB 2402, PB 2406, and the set of PBs may each be of varying sizes for reasons described above.

Per above, FIG. 24 illustrates the plurality of candidate BVDs and their corresponding PBs. In a first example, the further operations of a decoder are described with reference to plurality of candidate BVDs illustrated by FIG. 24.

The next decoder-side BVD refinement operation may be, for each respective candidate BVD of the plurality of candidate BVDs, determining a cost of a template of the PB displaced from PB 2406 by the respective candidate BVD. The next decoder-side BVD refinement operation may be selecting one or more of the plurality of candidate BVDs based on the costs.

In embodiments, the one or more of the plurality of candidate BVDs may correspond to a number of the plurality of the candidate BVDs with the smallest costs among the costs. In embodiments, the number may be the 12 candidate BVDs with the smallest costs among the costs. In embodiments, the determining the cost of the template of the PB displaced from the PB 2406 by the respective candidate BVD further comprises determining a difference between the template of the PB displaced from PB 2406 by the respective candidate BVD and the template of CB 2402. In embodiments, the difference may be a Sum of Absolute Differences (SAD).

In further embodiments, the decoder may receive, in a bitstream, an indication of a selected candidate BVD among the plurality of candidate BVDs, wherein the selected candidate BVD is the BVD. In embodiments, the selected candidate BVD may be the candidate BVD with the smallest costs among the costs.

In a second example, the further operations of an encoder are described with reference to plurality of candidate BVDs illustrated by FIG. 24.

The next encoder-side BVD refinement operation may be, for each respective candidate BVD of one or more of the plurality of candidate BVDs, determining a cost of the candidate BVD based on a PB displaced from PB 2406 by the respective candidate BVD. The next encoder-side BVD refinement operation may be signaling, in a bitstream, an indication of a selected candidate BVD from the one or more of the plurality of candidate BVDs based on the costs.

In embodiments, the next encoder-side BVD refinement operation may be determining, for each respective candidate BVD of the plurality of candidate BVDs, a cost of a template of the PB displaced from PB 2406 by the respective candidate BVD. The next encoder-side BVD refinement operation may be selecting the one or more of the plurality of candidate BVDs based on the costs. In embodiments, the one or more of the plurality of candidate BVDs may correspond to a number of the plurality of the candidate BVDs with the smallest costs among the costs. In embodiments, the number may be the 12 candidate BVDs with the smallest costs among the costs.

In embodiments, the determining the cost of the template of the PB displaced from PB 2406 by the respective candidate BVD further comprises determining a difference between the template of the PB displaced from PB 2406 by the respective candidate BVD and the template of CB 2402. In embodiments, the difference may be a Sum of Absolute Differences (SAD).

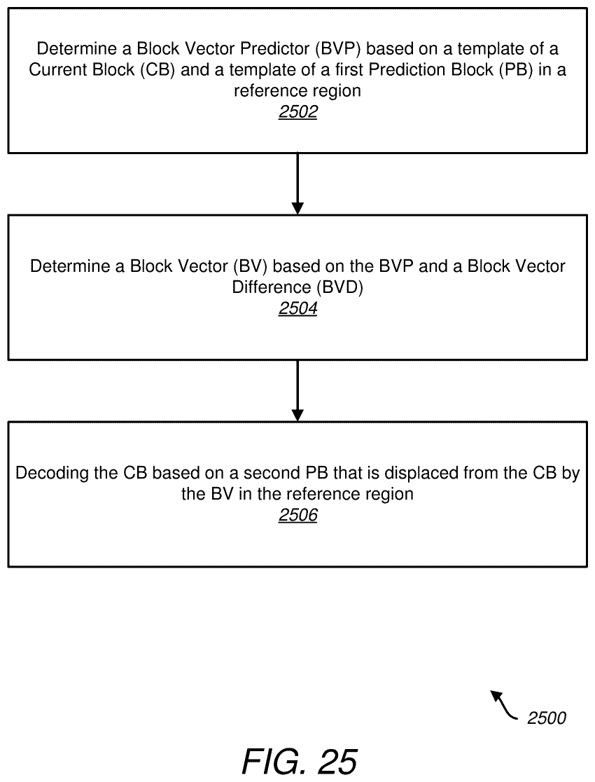

FIG. 25 illustrates a flowchart 2500 of a method for determining a BVP based on a template of a CB and a template of a first PB in a reference region, determining a BV based on the BVP and a BVD, and decoding the CB based on a second PB displaced from the CB by the BV in the reference region, in accordance with embodiments of the present disclosure. The method of flowchart 2500 may be implemented by a decoder, such as decoder 300 in FIG. 3.

The method of flowchart 2500 begins at step 2502. At step 2502, a BVP is determined based on a template of a CB and a template of a first PB in a reference region.

In an example, to perform TMP for predicting the CB, a decoder may determine or construct a template of the CB. After determining or constructing the template of the CB, the decoder may search a reconstructed region for a template of a PB that is determined to “best” match the template of the CB. For example, the decoder may determine that a template of the first PB is the “best” match to the template of the CB. After determining the template of the first PB that “best” matches the template of the CB, the decoder may determine a block vector predictor (BVP). For example, the BVP may indicate a vector displacement between the CB and the first PB. In an example, the decoder may determine the BVP based on a difference between the location of the CB and the location of the first PB. In another example, the decoder may not need to determine the BVP because the decoder determines the location of the first PB by TMP.

In an example, for each template of a plurality of templates in the reference region, a difference, among a set of differences, is determined between the template of the CB and each template. The template of the first PB is selected based on the set of differences. In an example, the set of differences comprises a set of Sums of Absolute Differences (SADs). In an example, the template of the first PB is selected based on a smallest Sum of Absolute Differences (SAD) among the set of SADs.

At step 2504, a BV is determined based on the BVP and a BVD.

In an example, the decoder may receive from the encoder, in a bitstream, an indication of the BVD. In another example, the decoder may determine the BV based on the BVP and the BVD. For example, the BVD may indicate the displacement of the second PB relative to the first PB, and the BV may indicate the displacement of the second PB relative to the CB. In an example, the decoder may determine the BV by adding the BVP to the BVD. In an example, the decoder may determine the location of the second PB by displacing the location of the CB by the BV. In another example, instead of determining the BV, the decoder may determine the location of the second PB by displacing the location of first PB (determined using TMP) by the BVD. For example, the decoder may add the horizontal component of the BVD to the horizontal location of the first PB and the vertical component of the BVD to the vertical location of the first PB to respectively determine the horizontal and vertical location of the second PB.

In an example, the BVD comprises a horizontal component and a vertical component. In an example, the horizontal component and the vertical component is received in a bitstream. In an example, the BVD comprises a magnitude and a direction. In an example, the magnitude is selected from a list of magnitude values. In an example, the magnitude values are represented in units of pixels. In an example, the magnitude values comprise: ¼, ½, 1, 2, 4, 8, 16, and 32. In an example, the magnitude values comprise: 1, 2, 4, 8, 16, 32, 48, 64, 80, 96, 112, and 128. In an example, the magnitude values comprise: 1, 2, 4, 8, 12, 16, 24, 32, 40, 48, 56, 64, 72, 80, 88, 96, 104, 112, 120, and 128.

In an example, the direction is selected from a list of directions. In an example, the directions comprise one or more of: a positive, horizontal direction; a negative, horizontal direction; a positive, vertical direction; and a negative, vertical direction. In an example, the BVD is determined based on an index to the magnitude in a list of magnitude values, and an index to the direction in a list of directions. In an example, the index to the magnitude and the index to the direction is received in a bitstream.

In an example, for each respective candidate BVD of a plurality of candidate BVDs, a cost of a template of a PB displaced from the first PB by the respective candidate BVD is determined. One or more of the plurality of candidate BVDs are selected based on the costs. In an example, the one or more of the plurality of candidate BVDs correspond to a number of the plurality of the candidate BVDs with the smallest costs among the costs. In an example, a difference between the template of the PB displaced from the first PB by the respective candidate BVD and the template of the CB is determined. In an example, the difference is a Sum of Absolute Differences (SAD).

In an example, an indication of a selected candidate BVD among the plurality of candidate BVDs is received in a bitstream, wherein the selected candidate BVD is the BVD. In an example, component-vector addition of the BVP and the BVD is performed. In an example, a BV horizontal component is determined by adding BVP horizontal component to a BVD horizontal component, and a BV vertical component is determined by adding a BVP vertical component to a BVD vertical component.

At step 2506, a CB is decoded based on a second PB that displaced from the CB by the BV in the reference region.

In an example, after determining the location of the second PB, the decoder may use the second PB to predict the CB. For example, the decoder may add the residual, received from the encoder, to the second PB to reconstruct the CB.

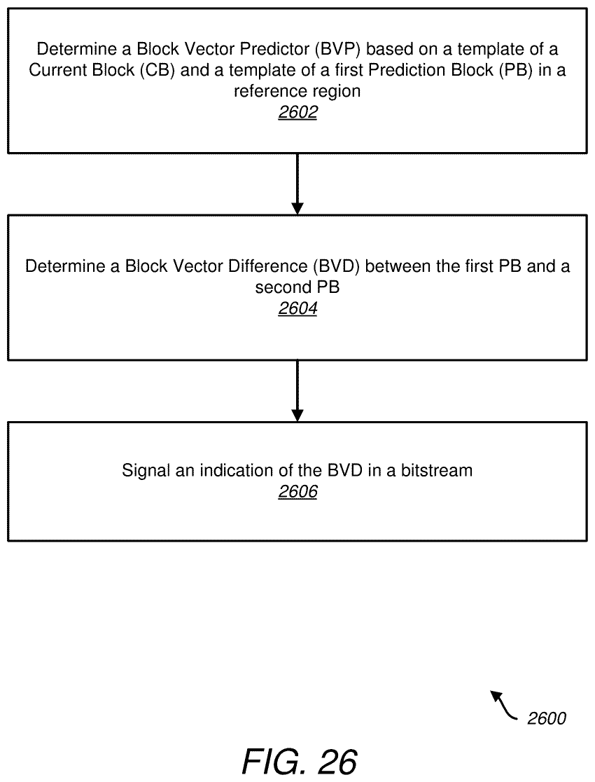

FIG. 26 illustrates a flowchart 2600 of a method for determining a BVP based on a template of a CB and a template of a first PB in a reference region, determining a BVD between the first PB and a second PB, and signaling an indication of the BVD in a bitstream, in accordance with embodiments of the present disclosure. The method of flowchart 2600 may be implemented by an encoder, such as encoder 200 in FIG. 2.

The method of flowchart 2600 begins at step 2602. At step 2602, a BVP is determined based on a template of a CB and a template of a first PB in a reference region.

In an example, to perform TMP for predicting the CB, an encoder may determine or construct a template of the CB. After determining or constructing the template of the CB, the encoder may search a reconstructed region for a template of a prediction block (PB) that is determined to “best” match the template of the CB. After determining a template of a first PB that “best” matches the template of the CB, the encoder may determine a block vector predictor (BVP). For example, the BVP may indicate a displacement of the first PB relative to the CB. In an example, the encoder may determine the BVP based on a difference between the location of the CB and the location of the first PB. In another example, the encoder may not determine the BVP because the encoder determines the location of the first PB by TMP.

In an example, for each template of a plurality of templates in the reference region, a difference, among a set of differences, is determined between the template of the CB and each template. The template of the first PB is selected based on the set of differences. In an example, the set of differences comprises a set of Sums of Absolute Differences (SADs). In an example, the template of the first PB is selected based on a smallest Sum of Absolute Differences (SAD) among the set of SADs.

At step 2604, a BVD between the first PB and a second PB is determined.

In an example, after determining the BVP, or after determining the location of the first PB by TMP, the encoder may determine that a second PB is a “better” match to the CB by determining a cost between the and one or more candidate prediction blocks (PBs) (e.g., including the first PB) in the reconstructed region. For example, the encoder may determine that the second PB is a “better” match to the CB than the first PB because the cost between the CB and the second PB is smaller than the cost between the CB and the first PB.

In an example, the encoder may determine a block vector difference (BVD). For example, the BVD may indicate the displacement of the second PB relative to the “best” matching PB or the first PB. In an example, the encoder may determine the BVD based on a difference between the location of the first PB and the location of the second PB (e.g., a difference between horizontal positions of the two locations and a difference between vertical positions of the two locations). After determining the BVD, and/or after determining the location of the second PB, the encoder may then use the second PB to predict the CB.

In an example, the BVD comprises a horizontal component and a vertical component. In an example, the horizontal component and the vertical component are signaled in a bitstream.

At step 2606, an indication of the BVD is signaled in a bitstream.

In further example embodiments, the encoder may determine a difference (e.g., a corresponding sample-by-sample difference) between the CB and the second PB. The difference may be referred to as a prediction error or residual. The encoder may then store and/or signal in a bitstream the prediction error or residual for decoding by the decoder.

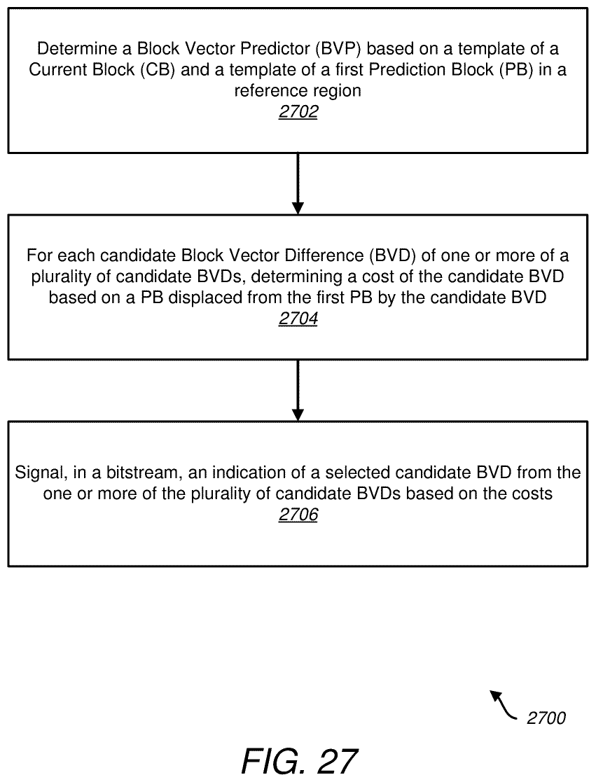

FIG. 27 illustrates a flowchart 2700 of a method for: determining a BVP based on a template of a CB and a template of a first PB in a reference region; for each respective candidate BVD of one or more of a plurality of candidate BVDs, determining a cost of the candidate BVD based on a PB displaced from the first PB by the respective candidate BVD; and, signaling, in a bitstream, an indication of a selected candidate BVD from the one or more of the plurality of candidate BVDs based on the costs, in accordance with embodiments of the present disclosure. The method of flowchart 2700 may be implemented by an encoder, such as encoder 200 in FIG. 2.

The method of flowchart 2700 begins at step 2702. At step 2702, a BVP is determined based on a template of a CB and a template of a first PB in a reference region.

In an example, to perform TMP for predicting the CB, an encoder may determine or construct a template of the CB. After determining or constructing the template of the CB, the encoder may search a reconstructed region for a template of a prediction block (PB) that is determined to “best” match the template of the CB. After determining a template of a first PB that “best” matches the template of the CB, the encoder may determine a block vector predictor (BVP). For example, the BVP may indicate a displacement of the first PB relative to the CB. In an example, the encoder may determine the BVP based on a difference between the location of the CB and the location of the first PB. In another example, the encoder may not determine the BVP because the encoder determines the location of the first PB by TMP.

In an example, for each template of a plurality of templates in the reference region, a difference, among a set of differences, is determined between the template of the CB and each template. The template of the first PB is selected based on the set of differences. In an example, the set of differences comprises a set of Sums of Absolute Differences (SADs). In an example, the template of the first PB is selected based on a smallest Sum of Absolute Differences (SAD) among the set of SADs.

At step 2704, for each respective candidate BVD of one or more of a plurality of candidate BVDs, a cost of the candidate BVD is determined based on a PB displaced from the first PB by the respective candidate BVD.

In an example, the encoder may determine a block vector difference (BVD). For example, the BVD may indicate the displacement of an other PB relative to the “best” matching PB or the first PB. In an example, the encoder may determine the BVD based on a difference between the location of the first PB and the location of the second PB (e.g., a difference between horizontal positions of the two locations and a difference between vertical positions of the two locations). After determining the BVD, and/or after determining the location of the second PB, the encoder may then use the second PB to predict the CB.

In an example, the BVD comprises a magnitude and a direction. In an example, the magnitude is selected from a list of magnitude values. In an example, the magnitude values are represented in units of pixels. In an example, the magnitude values comprise: ¼, ½, 1, 2, 4, 8, 16, and 32. In an example, the magnitude values comprise: 1, 2, 4, 8, 16, 32, 48, 64, 80, 96, 112, and 128. In an example, the magnitude values comprise: 1, 2, 4, 8, 12, 16, 24, 32, 40, 48, 56, 64, 72, 80, 88, 96, 104, 112, 120, and 128.

In an example, the direction is selected from a list of directions. In an example, the directions comprise one or more of: a positive, horizontal direction; a negative, horizontal direction; a positive, vertical direction; and a negative, vertical direction. In an example, the BVD is determined based on an index to the magnitude in a list of magnitude values, and an index to the direction in a list of directions. In an example, the index to the magnitude and the index to the direction is received in a bitstream.

In an example, for each respective candidate BVD of a plurality of candidate BVDs, a cost of a template of the PB displaced from the first PB by the respective candidate BVD is determined. One or more of the plurality of candidate BVDs are selected based on the costs. In an example, the one or more of the plurality of candidate BVDs correspond to a number of the plurality of the candidate BVDs with the smallest costs among the costs. In an example, a difference between the template of the PB displaced from the first PB by the respective candidate BVD and the template of the CB is determined. In an example, the difference is a Sum of Absolute Differences (SAD).

At step 2706, an indication of a selected candidate BVD from the one or more of the plurality of candidate BVDs based on the costs is signaled in a bitstream. In an example, an indication of a selected candidate BVD among the plurality of candidate BVDs is signaled in a bitstream, wherein the selected candidate BVD is the BVD.

In further example embodiments, the encoder may determine a difference (e.g., a corresponding sample-by-sample difference) between the CB and the second PB. The difference may be referred to as a prediction error or residual. The encoder may then store and/or signal in a bitstream the prediction error or residual for decoding by the decoder.

Although the foregoing description is primarily directed to using TMP for intra prediction, for example, prediction within the same picture (or frame) of a given video sequence, it should be understood that the techniques of the present disclosure described above and further below may be applied to other prediction modes. It should be further understood that TMP may be performed on more than one frame in a given video sequence, for example, inter prediction. For example, TMP may be applied to relatively static content elements in more than one frame. For cam era-captured content, these content elements may be portions of frames that are not moving over time (“static”), such as reoccurring textures. For screen-captured content, these content elements may also be portions of frames that are not moving over time (“static”), such as reoccurring characters, graphics, or user interfaces. A potential benefit of applying TMP to inter prediction is that the signaling overhead for signaling the motion information to predict the current block may be reduced in size.

From a high-level perspective, in order to apply the embodiments of TMP described above to inter prediction, instead of intra prediction, three key conceptual changes may be made. The first key conceptual change is that instead of a block vector (BV) used in intra prediction, inter prediction uses a motion vector (MV). Thus, TMP operations on block vector(s) may need to be adapted to motion vector(s). The second key conceptual change is that instead of predicting content within one current frame as in intra prediction, inter predicts content by comparing one or more frames to a current frame. Thus, TMP operations may need to be adapted to comparing one or more frames to a current frame, instead of comparing content within one current frame. The third key conceptual change is that instead of directly comparing block contents in the inter prediction embodiments discussed above, templates of blocks may need to be used for comparison. Each related conceptual change is discussed more detail below.

Firstly, the adaptations from block vector(s) (BV(s)) to motion vector(s) (MV(s)) are discussed per below.

A motion vector (MV) is similar to a block vector (BV) because it comprises a horizontal component and a vertical component. The primary distinction is that an MV may indicate a magnitude and direction of motion from a first block to a second block in more than one frame, rather than a magnitude and direction of displacement from a first block to a second block in one frame as in a BV.

Further, a motion vector predictor (MVP) is similar to a block vector predictor (BVP) because the encoder may code an MV using the AMVP tool as a difference between the MV of a current block being coded and a motion vector predictor (MVP). Further, a motion vector difference (MVD) is similar to a block vector difference (BVD) because the encoder may determine an MVD based on the difference between the MV of the current block and the selected MVP.

Further, the mathematical relationship between an MV, MVP and MVD is similar to the mathematical relationship between a BV, BVP, and BVD discussed above. For an encoder, the MVD may be determined as the difference between the MV of the current block and the MVP. For example, for an MV represented by a horizontal component (MVₓ) and a vertical displacement (MV_{y}) relative to the position of the current block being coded, the MVD may be represented by two components calculated as follows:

$${MVD}_{x} = {MV}_{x} - {MVP}_{x} \qquad ( 21 )$$

$${MVD}_{y} = {MV}_{y} - {MVP}_{y} \qquad ( 22 )$$

where MVDₓ and MVD_{y} respectively represent the horizontal and vertical components of the MVD, and MVPₓ and MVP_{y} respectively represent the horizontal and vertical components of the MVP. Conversely, for a decoder, the MV may be determined by adding the MVD to the MVP. For example, for a motion vector represented by a horizontal component (MVₓ) and a vertical displacement (MV_{y}) relative to the position of the current block being coded, the MV may be represented by two components calculated as follows:

$${MV}_{x} = {MVP}_{x} + {MVD}_{x} \qquad ( 23 )$$

$${MV}_{y} = {MVP}_{y} + {MVD}_{y} \qquad ( 24 )$$

where MVDₓ and MVD_{y} respectively represent the horizontal and vertical components of the MVD, and MVPₓ and MVP_{y} respectively represent the horizontal and vertical components of the MVP.

Secondly, the adaptations for comparing content in one or more frames to a current frame are discussed in more detail below.

An example implementing the adaptations of TMP to inter prediction is now discussed with reference to FIG. 13A and FIG. 13B, illustrating inter prediction, with comparison to FIG. 19, illustrating TMP according to embodiments of the present disclosure.

In FIG. 13A, the current picture 1302 includes current block 1300. Current block 1300 is conceptually similar to current block 1902 (e.g., of FIG. 19). For example, both current block 1300 and current block 1902 may be the target of the prediction operations by the encoder and decoder. Further in FIG. 13A, the reference picture 1306 includes search range 1308. Search range 1308 is conceptually similar to reconstructed region 1906 (e.g., of FIG. 19). For example, both search range 1308 and reconstructed region 1906 may be searched by the encoder and decoder to locate a block for prediction of the current block. Further in FIG. 13A, the search range 1308 may include collocated block 1310, motion vector 1312, and reference block 1304.

Motion vector 1312 is conceptually similar to block vector 1918 (e.g., of FIG. 19), and reference block 1304 is conceptually similar to prediction block 1914 (e.g., of FIG. 19). For example, motion vector 1312 indicates reference block 1304 may be used for prediction of current block 1300, and block vector 1918 indicates the prediction block 1914 may be used for prediction of current block 1902.

Further, collocated block 1310 is conceptually similar to prediction block 1910 (e.g., of FIG. 19). For example, collocated block 1310 may be used as a starting point for the motion vector 1312 that indicates reference block 1304 may be used for prediction of current block 1300; similarly, prediction block 1910 may be used as a starting point for the block vector difference 1916 that indicates prediction block 1914 may be used for prediction of current block 1902. In FIG. 13A and FIG. 13B, the MVP and MVD used in inter prediction are not illustrated. However, the MVP and MVD may be used in combination to represent motion vector 1312, in a similar manner as BVP 1912 and BVD 1916 may be used in combination to represent block vector 1918.

Thirdly, the adaptations from directly comparing block contents to comparing templates of blocks are discussed in more detail below.

With comparison to FIG. 19, and other further embodiments of TMP discussed above, template 1904 of current block 1902 may be used to search for a matching template of one or more prediction blocks, for example, prediction block 1910. A similar template-matching search may be adapted to the inter prediction embodiment illustrated by FIG. 13A and FIG. 13B. For example, instead of comparing the contents of collocated block 1310 to reference block 1304 in search range 1308, a template of collocated block 1310 may be compared to a template of reference block 1304 to determine a matching prediction block of current block 1300.

With additional reference to FIG. 14, this illustration embodies inter prediction applied to comparing two reference blocks (1402 and 1404) in two other frames to a current block in a current frame. In this example, the two reference blocks 1402 and 1404, indicated by motion vector 1406 and motion vector 1408 respectively, may both be used to predict the current block 1400. This embodiment of inter prediction is conceptually similar to the embodiment of TMP with BVD Refinement of FIG. 24 described above. For example, in FIG. 24, two or more prediction blocks may be determined and used by the encoder or decoder for predicting the current block.

Further, whereas it is more common for intra modes, e.g., IBC, to use integer magnitudes, fractional magnitudes are frequently more useful for representing motion vector data between frames. A motion vector with fractional resolution may point between two samples in a reference picture to provide a better estimation of the motion of a current block. The embodiments of magnitude list 2206 in FIG. 22 and magnitude list 2300 in FIG. 23 discussed above include example fractional magnitude values (e.g., ¼-pixel, and ½-pixel) that may enhance vector-representation flexibility when used in an inter prediction mode.

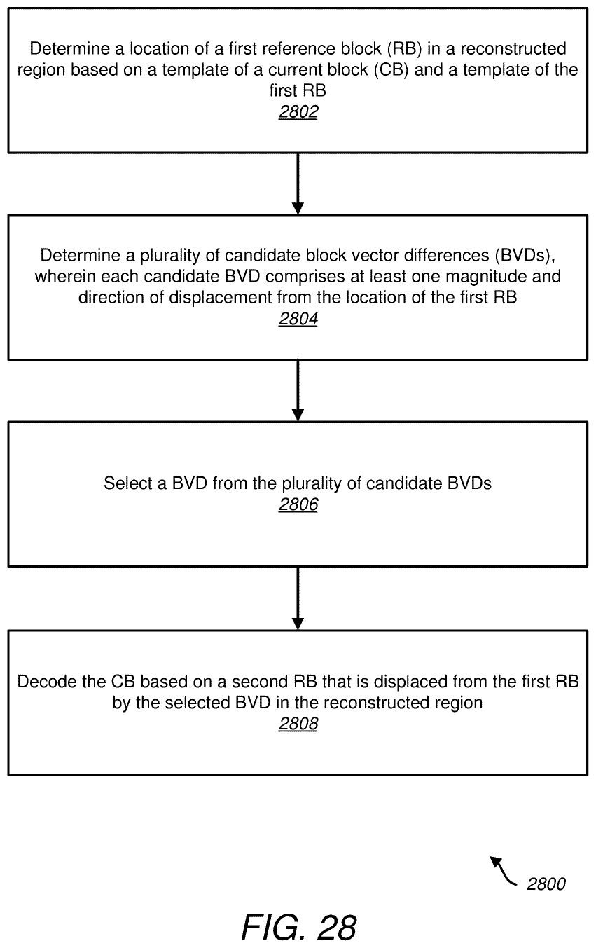

FIG. 28 illustrates a flowchart 2800 of a method for determining a location of a first reference block (RB) using TMP and determining a plurality of candidate BVDs displaced from the location of the first RB for BVD refinement, in accordance with embodiments of the present disclosure. The method of flowchart 2800 may be implemented by a decoder, such as decoder 300 in FIG. 3.

The method of flowchart 2800 begins at 2802. At 2802, the decoder determines a location of a first reference block (RB) in a reconstructed region based on a template of a current block (CB) and a template of the first RB. In an example, the determining the location of the first RB in the reconstructed region based on the template of the CB and the template of the first RB may further comprise, for each template of a plurality of templates in the reconstructed region, determining a cost of each template, and selecting the template of the first RB, from the plurality of templates, based on the costs. In an example, the determining the cost of each template may further comprise determining a difference between each template and the template of the CB. In an example, the difference may be a sum of absolute differences (SAD). In an example, the selecting the template of the first RB may be based on the template of the first RB having a smallest cost among the costs. In an example, the location of the first RB may be indicated by a block vector predictor (BVP), and the BVP may indicate a displacement from the CB to the first RB.

At 2804, the decoder determines a plurality of candidate block vector differences (BVDs), wherein each candidate BVD comprises at least one magnitude and direction of displacement from the location of the first RB. In an example, the determining the plurality of candidate BVDs may further comprise determining each candidate BVD based on the at least one magnitude and direction of displacement from the location of the first RB, wherein the magnitude is selected from a list of magnitude values and the direction is selected from a list of directions. In an example, the magnitude values may be represented in units of pixels. In an example, the magnitude values may comprise: ¼, ½, 1, 2, 4, 8, 16, 32, 40, 48, 56, 64, 72, 80, 88, 96, 104, 112, 120, and 128. In an example, the directions may comprise one or more of: a positive, horizontal direction; a negative, horizontal direction; a positive, vertical direction; and a negative, vertical direction. In an example, the determining each candidate BVD further comprises receiving, in a bitstream, an index to the magnitude in a list of magnitude values, and an index to the direction in a list of directions.

At 2806, the decoder selects a BVD from the plurality of candidate BVDs. In an example, the selecting the BVD from the plurality of candidate BVDs may further comprise, for each respective candidate BVD of the plurality of candidate BVDs, determining a cost of a template of an RB displaced from the first RB by the respective candidate BVD, and selecting the BVD from the plurality of candidate BVDs based on the costs. In an example, the determining the cost of the template of the RB displaced from the first RB by the respective candidate BVD may further comprise determining a difference between the template of the RB displaced from the first RB by the respective candidate BVD and the template of the CB. In an example, the difference may be a sum of absolute differences (SAD). In an example, the decoder may further receive, in a bitstream, an indication of a selected candidate BVD among the plurality of candidate BVDs, wherein the selected candidate BVD is the selected BVD.

And, at 2808, the decoder decodes the CB based on a second RB that is displaced from the first RB by the selected BVD in the reconstructed region. In an example, the decoding the CB based on the second RB that is displaced from the first RB by the selected BVD in the reconstructed region may further comprise adding the second RB to a residual of the CB. In an example, the decoder may further receive, in a bitstream, the residual of the CB.

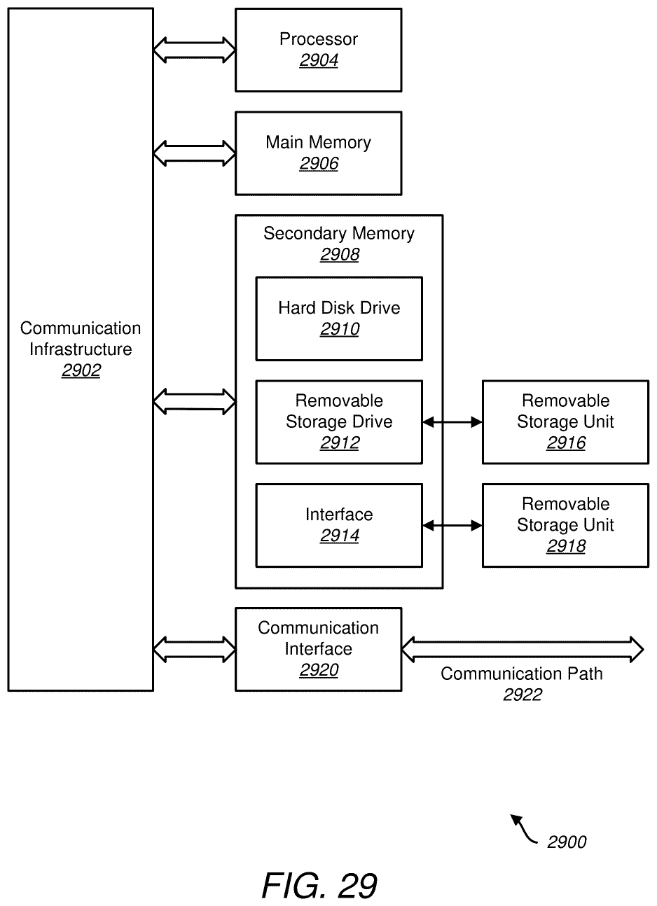

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2900 is shown in FIG. 29. Blocks depicted in the figures above, such as the blocks in FIGS. 1, 2, and 3, may execute on one or more computer systems 2900. Furthermore, each of the steps of the flowcharts depicted in this disclosure may be implemented on one or more computer systems 2900.

Computer system 2900 includes one or more processors, such as processor 2904. Processor 2904 may be, for example, a special purpose processor, general purpose processor, microprocessor, or digital signal processor. Processor 2904 may be connected to a communication infrastructure 2902 (for example, a bus or network). Computer system 2900 may also include a main memory 2906, such as random access memory (RAM), and may also include a secondary memory 2908.

Secondary memory 2908 may include, for example, a hard disk drive 2910 and/or a removable storage drive 2912, representing a magnetic tape drive, an optical disk drive, or the like. Removable storage drive 2912 may read from and/or write to a removable storage unit 2916 in a well-known manner. Removable storage unit 2916 represents a magnetic tape, optical disk, or the like, which is read by and written to by removable storage drive 2912. As will be appreciated by persons skilled in the relevant art(s), removable storage unit 2916 includes a computer usable storage medium having stored therein computer software and/or data.

In alternative implementations, secondary memory 2908 may include other similar means for allowing computer programs or other instructions to be loaded into computer system 2900. Such means may include, for example, a removable storage unit 2918 and an interface 2914. Examples of such means may include a program cartridge and cartridge interface (such as that found in video game devices), a removable memory chip (such as an EPROM or PROM) and associated socket, a thumb drive and USB port, and other removable storage units 2918 and interfaces 2914 which allow software and data to be transferred from removable storage unit 2918 to computer system 2900.

Computer system 2900 may also include a communications interface 2920. Communications interface 2920 allows software and data to be transferred between computer system 2900 and external devices. Examples of communications interface 2920 may include a modem, a network interface (such as an Ethernet card), a communications port, etc. Software and data transferred via communications interface 2920 are in the form of signals which may be electronic, electromagnetic, optical, or other signals capable of being received by communications interface 2920. These signals are provided to communications interface 2920 via a communications path 2922. Communications path 2922 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 2916 and 2918 or a hard disk installed in hard disk drive 2910. These computer program products are means for providing software to computer system 2900. Computer programs (also called computer control logic) may be stored in main memory 2906 and/or secondary memory 2908. Computer programs may also be received via communications interface 2920. Such computer programs, when executed, enable the computer system 2900 to implement the present disclosure as discussed herein. In particular, the computer programs, when executed, enable processor 2904 to implement the processes of the present disclosure, such as any of the methods described herein. Accordingly, such computer programs represent controllers of the computer system 2900.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art.

What is claimed is:

1. A method comprising:
determining, in a reference region having dimensions based on dimensions of a current block, a location of a first reference block (RB) based on a template of the current block and a template of the first RB;
receiving an indication of a block vector difference (BVD) from a bitstream; and
decoding the current block based on a second RB at a location that is displaced from the location of the first RB by the BVD.

2. The method of claim 1, wherein the determining the location of the first RB comprises:
determining, for each template of a plurality of templates in the reference region, a difference between the template of the current template and each template; and
selecting the template of the first RB based on the differences.

3. The method of claim 1, further comprising:
for each respective candidate BVD of a plurality of candidate BVDs, determining a cost of a template of an reference block displaced from the first RB by the respective candidate BVD; and
selecting one or more candidate BVDs of the plurality of candidate BVDs based on the costs, wherein the indication of the BVD indicates one of the one or more candidate BVDs.

4. The method of claim 1, wherein the indication of the BVD comprises:
a horizontal component of the BVD; and
a vertical component of the BVD.

5. The method of claim 1, wherein the indication of the BVD comprises:
an index to a magnitude in a list of magnitude values; and
an index to a direction in a list of directions, wherein the BVD is determined based on the magnitude and the direction.

6. The method of claim 5, wherein the list of directions comprises a positive horizontal direction, a negative horizontal direction, a positive vertical direction, and a negative vertical direction.

7. The method of claim 1, wherein the decoding the current block comprises adding the second reference block to a residual of the current block received in the bitstream.

8. A decoder comprising:
one or more processors; and
memory storing instructions that, when executed by the one or more processors, cause the decoder to:
determine, in a reference region having dimensions based on dimensions of a current block, a location of a first reference block (RB) based on a template of the current block and a template of the first RB;
receive an indication of a block vector difference (BVD) from a bitstream; and
decode the current block based on a second RB at a location that is displaced from the location of the first RB by the BVD.

9. The decoder of claim 8, wherein to determine the location of the first RB, the instructions further cause the decoder to:
determine, for each template of a plurality of templates in the reference region, a difference between the template of the current template and each template; and
select the template of the first RB based on the differences.

10. The decoder of claim 8, wherein the instructions further cause the decoder to:
for each respective candidate BVD of a plurality of candidate BVDs, determine a cost of a template of an reference block displaced from the first RB by the respective candidate BVD; and
select one or more candidate BVDs of the plurality of candidate BVDs based on the costs, wherein the indication of the BVD indicates one of the one or more candidate BVDs.

11. The decoder of claim 8, wherein the indication of the BVD comprises:
a horizontal component of the BVD; and
a vertical component of the BVD.

12. The decoder of claim 8, wherein the indication of the BVD comprises:
an index to a magnitude in a list of magnitude values; and
an index to a direction in a list of directions, wherein the BVD is determined based on the magnitude and the direction.

13. The decoder of claim 12, wherein the list of directions comprises a positive horizontal direction, a negative horizontal direction, a positive vertical direction, and a negative vertical direction.

14. The decoder of claim 8, wherein to decode the current block, the instructions further cause the decoder to add the second reference block to a residual of the current block received in the bitstream.

15. A non-transitory computer-readable medium comprising instructions that, when executed by one or more processors of a decoder, cause the decoder to:
determine, in a reference region having dimensions based on dimensions of a current block, a location of a first reference block (RB) based on a template of the current block and a template of the first RB;
receive an indication of a block vector difference (BVD) from a bitstream; and
decode the current block based on a second RB at a location that is displaced from the location of the first RB by the BVD.

16. The non-transitory computer-readable medium of claim 14, wherein to determine the location of the first RB, the instructions further cause the decoder to:
determine, for each template of a plurality of templates in the reference region, a difference between the template of the current template and each template; and
select the template of the first RB based on the differences.

17. The non-transitory computer-readable medium of claim 14, wherein the instructions further cause the decoder to:
for each respective candidate BVD of a plurality of candidate BVDs, determine a cost of a template of an reference block displaced from the first RB by the respective candidate BVD; and
select one or more candidate BVDs of the plurality of candidate BVDs based on the costs, wherein the indication of the BVD indicates one of the one or more candidate BVDs.

18. The non-transitory computer-readable medium of claim 14, wherein the indication of the BVD comprises:
a horizontal component of the BVD; and
a vertical component of the BVD.

19. The non-transitory computer-readable medium of claim 14, wherein the indication of the BVD comprises:
an index to a magnitude in a list of magnitude values; and
an index to a direction in a list of directions, wherein the list of directions comprises a positive horizontal direction, a negative horizontal direction, a positive vertical direction, and a negative vertical direction, and wherein the BVD is determined based on the magnitude and the direction.

20. The non-transitory computer-readable medium of claim 14, wherein to decode the current block, the instructions further cause the decoder to add the second reference block to a residual of the current block received in the bitstream.
